(19) United States
(12) Patent Application Publication
(10) Pub. No.: US 2024/0114902 A1
(43) Pub. Date: Apr. 11, 2024

(54) COMPOSITIONS AND METHODS FOR DETERRING OVIPOSITION BY FRUIT FLIES

(71) Applicant: The United States of America, as represented by The Secretary of Agriculture, Washington, DC (US)

(72) Inventors: DONG H. CHA, HILO, HI (US); JUNWEI J. ZHU, LINCOLN, NE (US)

(21) Appl. No.: 18/477,665

(22) Filed: Sep. 29, 2023

Related U.S. Application Data
(60) Provisional application No. 63/414,216, filed on Oct. 7, 2022.

(51) Int. Cl. A01N 37/02; A01N 37/06; A01P 17/00

(52) U.S. Cl. CPC A01N 37/02; A01N 37/06; A01P 17/00

(57) ABSTRACT

Biocontrol compositions effective as fruit fly oviposition deterrents are disclosed. Compositions comprising at least two coconut free fatty acids (CFA), caprylic acid (C_{8:0}) and capric acid (C_{10:0}), and optionally a carrier are shown to be effective drosophilid oviposition-deterrents. Furthermore, other specific CFA are shown to reduce female B. dorsalis, Z. cucurbitae, and D. suzukii attraction and oviposition in response to host fruit odors. Kits comprising such biocontrol compositions, and methods of using such biocontrol compositions to reduce the population of fruit flies are also taught.

### CROSS-REFERENCE TO RELATED APPLICATIONS

This application claims the benefit of U.S. Provisional Application No. 63/414,216 filed Oct. 7, 2022. The content of this provisional patent application is hereby expressly incorporated by reference in its entirety.

### FIELD

The disclosure relates biocontrol compositions that deter fruit fly oviposition reducing infestation of these fruit flies on their preferred host fruits; kits comprising such compositions; and methods of using such compositions to reduce fruit fly populations.

### BACKGROUND

Invasive tephritid fruit flies, such as Bactrocera dorsalis, Zeugodacus cucurbitae, B. latifrons, Ceratitis capitata, and Anastrepha ludens are among the most destructive agricultural pests and make incursions into important agricultural areas in the U.S. mainland every year. Once established, these flies can become serious trade-barriers of U.S. produced fruits. Unfortunately, the frequency of the incursions has risen, suggesting an increased likelihood that a catastrophic outbreak could occur. For example, in August 2015, establishment of a breeding population of B. dorsalis in southern Florida caused at least US$4.1 M in direct crop damages and triggered a 6-month quarantine and eradication programs costing an estimated US$3.5 M. Current fruit fly invasion prevention programs focus on control and surveillance of male fruit flies using combinations of sterile insect technique (SIT), male annihilation technique (MAT), and extensive networks of male surveillance traps. However, this strategy is less effective for mitigating the impact caused by invading female populations. In addition, some species are already causing economic damage to commercial fruit production in Hawaii (B. dorsalis, Z. cucurbitae, C. capitata, B. olea), Florida (A. suspensa), and California (B. olea) where these pests are established. Although bait sprays (protein+insecticides) have been effective to control these flies, there has been increasing evidence for the development of resistance to bait sprays.

Spotted wing Drosophila (SWD), Drosophila suzukii Matsumura, is a serious direct pest of soft fruit crops throughout the USA, Europe, and other regions. Unlike other drosophilids, SWD can oviposit into intact and marketable soft-skinned fruit, with berry and cherry crops especially vulnerable. Since it was first detected in the USA and Europe in 2008, there have been rapid increases in crop damage, pesticide use, and economic losses. Growers have responded to SWD infestation with pre-emptive and excessive use of broad-spectrum insecticides, which has led to increased production costs (direct and indirect), increased human health risks, reduced populations of beneficial organisms, and increased risk of insecticide resistance development. SWD also became a serious trade-barrier for export markets. For example, to mitigate the threat of SWD introduction, some countries such as Australia have mandated pre-shipment quarantine treatment as a biosecurity measure of fresh fruits imported from SWD-established countries. Thus, there is a critical need for alternative approaches that sustainably reduce SWD damage and oviposition on host fruit as part of a systems approach during pre- and postharvest processes.

There has been increased interest in developing behaviorally-based alternative approaches to control SWD infestation of fruit. These approaches often rely on the use of semiochemicals with different behavioral mode (e.g., attractants, deterrents, or arrestants), often in combinations. For example, in push-pull management system of SWD, an attractive lure and trap could capture and remove the SWD flies repelled by aversive odors released around the focal crop. In attract-and-kill system, attractants could be used to lure SWD to toxin-laced bait sprays or bait stations. During the last decade, many studies have explored and identified SWD attractants ranging from home-made baits based on fermentation to commercial synthetic lures. For repellents, several promising repellent plants have been shown to be effective at reducing SWD fruit damage. Additionally, synthetic chemicals such as 1-octen-3-ol and 2-pentylfuran have been shown to repel SWD when released around host fruit from vials, plastic sachets, or puffers. To be effective, these highly volatile spatial repellents need to be released and maintained around target crop at their behaviorally-effective concentrations using controlled release dispensers. Antagonistic chemicals with lower volatility may retain their efficacy longer and require fewer applications.

The oriental fruit fly (OFF), Bactrocera dorsalis (Hendel) (Diptera: Tephritidae), is one of the most destructive agricultural pests, known to attack more than 430 hosts, including many important economic crops. OFF is a serious agricultural pest where it is native or already established. In addition, OFF is a serious quarantine pest in many countries and could act as a potential trade-barrier. OFF has made repeated incursions into the U.S. since its first detection in 1960 in California and the frequency and size of OFF incursions have been accelerating. The threat posed by OFF to cause catastrophic trade disruption and reduced availability and marketability of produce is escalating.

Current OFF programs in the US focus on control and surveillance of male flies using combinations of sterile insect technique, male annihilation technique, and extensive networks of male monitoring traps based on methyl eugenol. Although these strategies have been effective at preventing OFF from being established, they are less effective for directly mitigating the damage caused by invading female populations. For example, in 2015, the detection of a breeding population of OFF in Miami-Dade County, Florida triggered a 6-month quarantine and eradication program costing an estimated US$3.5 M. Additionally, the incursion caused US$4.1 M in damage due to mandated crop destruction to control for larvae in fruit. Where OFF is established, the current strategy for controlling damage to fruit focuses on applications of bait sprays (i.e., protein bait+insecticide) and insecticides. Although these treatments have been effective at reducing fruit damage from OFF females, there is increasing evidence for the development of pesticide resistance.

Among topical fruit flies, Zeugodacus cucurbitae (melon fly) is considered the most destructive invasive pest of cucurbits. Using their hard and pointed ovipositor, female flies can infest fruits and flowers of more than 100 plants including many commercially important crops such as melon, watermelons, gourd, beans, pumpkin, tomato, squash, eggplant, and cucumber. It is native to India and southeastern Asia, and has been invading agriculturally important states of the U. S. mainland such as Californian and Florida since 1954, with its invasion frequency increasing in recent years. Once established, it can become a serious barrier of many agricultural crops.

The primary eradication and management strategies of Z. cucurbitae have been using protein bait sprays, baited male lure traps (e.g. cue-lure), fruit bagging, field sanitation, and sterile insect technique. The GF-120® insecticide (protein bait+spinosad; Dow Agrosciences, Indianapolis, Idiana, USA) is the most widely used bait spray based on the attract and kill strategy. Although effective, almost exclusive use of GF-120® insecticide has led to resistance developments in Z. cucurbitae. The male annihilation technique (MAT) and the sterile insect technique (SIT) have been effective for Z. cucurbitae eradication. However, MAT and SIT target only male flies and do not directly control female flies or damage by female flies, which are responsible for actual fruit infestation and population establishment.

Natural products as oviposition-deterrents against tephritid fruit flies have been explored extensively as an alternative control strategy. Several vegetable oils and plant extracts or chemicals have been shown to have oviposition-deterrent properties against Bactrocera zonata and Ceratitis capitata. For OFF, neem seed kernel extract and neem oil have been shown to have oviposition-deterrent activities (Singh R P and Srivastava B G, 1983, “Alcohol extract of neem (Azadirachta indica A. Juss) seed oil as oviposition deterrent for Dacus ctlcurhitae (Coq.),” Indian J. Entomol. 45: 497-498; Chen C C et al., 1996, “Deterrent effect of neem seed kernel extract on oviposition of the oriental fruit fly (Diptera: Tephritidae) in guava, J. Econ. Entomol. 89: 462-466; Sing S and Singh R P, 1998, “Neem (Azadirachta indica) seed kernel extracts and azadirachtin as oviposition deterrents against the melon fly (Bactrocera cucurbitae) and the oriental fruit fly (Bactrocera dorsalis),” Phytoparasitica 26: 191-197). Recently, coconut free fatty acids (CFA), a mixture of four medium-chain length free fatty acids [caprylic acid (C_{8:0}), capric acid (C_{10:0}), lauric acid (C_{12:0}), and myristic acid (C_{14:0})] and four long-chain free fatty acids [palmitic acid (C_{16:0}), stearic acid (C_{18:0}), oleic acid (C_{18:1}) and linoleic acid (C_{18:2})] derived from coconut oil, have been shown to have strong repellent activities against a broad array of blood-sucking arthropods, including biting flies, bed bugs, ticks and mosquitoes, with different key compounds effective for different species (Zhu J J et al., 2018, “Better than DEET repellent compounds derived from coconut oil,” Sci. Rep. 8: 14053; Roh G H et al., 2020, “Spatial repellency, antifeedant activity and toxicity of three medium chain fatty acids and their methyl esters of coconut fatty acid against stable flies,” Pest Manag. Sci. 76: 405-414). However, the antagonistic nature of CFA on fruit-infesting insects has not been studied.

Thus, there is a critical need to develop alternative control methods to protect host fruit from female flies in order to help avoid or reduce ensuing economic costs associated with crop loss and trade restrictions. Thus, new methods of prevention and control of fruit flies are needed.

### SUMMARY

Provided herein are biocontrol compositions comprising free fatty acids, kits comprising such biocontrol compositions, and methods of using such biocontrol compositions to reduce the population of fruit flies.

In an embodiment, the disclosure relates to a fruit fly oviposition deterrent composition comprising at least two coconut free fatty acids (CFA), caprylic acid (C_{8:0}) and capric acid (C_{10:0}), and optionally a carrier. In some embodiments of the disclosure, the composition comprises caprylic acid (C_{8:0}), capric acid (C_{10:0}), and at least one of oleic acid (C_{18:1}) and linoleic acid (C_{18:2}). In some embodiments of the disclosure, the composition comprises caprylic acid (C_{8:0}), capric acid (C:_{10:0}), oleic acid (C_{18:1}), and linoleic acid (C_{18:2}). In some embodiments of the disclosure, the composition comprises caprylic acid (C_{8:0}), capric acid (C:_{10:0}), oleic acid (C_{18:1}), and linoleic acid (C_{18:2}), and at least one of myristic acid (C_{14:0}) or lauric acid (C_{12:0}). In some embodiments, the composition comprises caprylic acid (C_{8:0}), capric acid (C:_{10:0}), stearic acid (C_{18:0}), oleic acid (C_{18:1}), and linoleic acid (C_{18:2}).

In some embodiments of the disclosure, the CFA are present in the composition from about 2 mg CFA-equivalent dose to about 20 mg CFA-equivalent dose. In some embodiments of the disclosure, the CFA are present in the composition at about 20 mg CFA-equivalent dose. In some embodiments of the disclosure, the CFA are present in the composition at about 2 mg CFA-equivalent dose. In some embodiments of the disclosure, the composition comprises an agronomically-, physiologically-, or pharmaceutically-acceptable carrier. In some embodiments of the disclosure, the composition comprises a vegetable oil. In some embodiments of the disclosure, the vegetable oil in the composition is canola oil, cottonseed oil, grapeseed oil, rapeseed oil, soybean oil, safflower oil, peanut oil, corn oil, olive oil, palm oil, or sunflower oil carrier. In some embodiments of the disclosure, the composition is a concentrate, a solution, a spray, a powder, a granule, a gel, a net, a film, or a wax.

In an embodiment, the disclosure relates to a method for deterring fruit fly oviposition on fruit, the method comprising treating the fruit or an area surrounding the fruit with a composition comprising at least two coconut free fatty acids (CFA), caprylic acid (C_{8:0}) and capric acid (C_{10:0}), and optionally a carrier. In some embodiments of the disclosure, the composition comprises caprylic acid (C_{8:0}), capric acid (C_{10:0}), and at least one of oleic acid (C_{18:1}) and linoleic acid (C_{18:2}). In some embodiments of the disclosure, the composition comprises caprylic acid (C_{8:0}), capric acid (C:_{10:0}), oleic acid (C_{18:1}), and linoleic acid (C_{18:2}). In some embodiments of the disclosure, the composition comprises caprylic acid (C_{8:0}), capric acid (C:_{10:0}), oleic acid (C_{18:1}), and linoleic acid (C_{18:2}), and at least one of myristic acid (C_{14:0}) or lauric acid (C_{12:0}). In some embodiments, the composition comprises caprylic acid (C_{8:0}), capric acid (C:_{10:0}), stearic acid (C_{18:0}), oleic acid (C_{18:1}), and linoleic acid (C_{18:2}).

In an embodiment, the disclosure relates to a kit for deterring fruit fly oviposition on fruit, the kit comprising a composition comprising at least two coconut free fatty acids (CFA), caprylic acid (C_{8:0}) and capric acid (C_{10:0}), and optionally a carrier. In some embodiments of the disclosure, the composition comprises caprylic acid (C_{8:0}), capric acid (C_{10:0}), and at least one of oleic acid (C_{18:1}) and linoleic acid (C_{18:2}). In some embodiments of the disclosure, the composition comprises caprylic acid (C_{8:0}), capric acid (C:_{10:0}), oleic acid (C_{18:1}), and linoleic acid (C_{18:2}). In some embodiments of the disclosure, the composition comprises caprylic acid (C_{8:0}), capric acid (C:_{10:0}), oleic acid (C_{18:1}), and linoleic acid (C_{18:2}), and at least one of myristic acid (C_{14:0}) or lauric acid (C_{12:0}). In some embodiments, the composition comprises caprylic acid (C_{8:0}), capric acid (C:_{10:0}), stearic acid (C_{18:0}), oleic acid (C_{18:1}), and linoleic acid (C_{18:2}).

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A to FIG. 1D depict graphs of the number (mean±SEM) of Bactrocera dorsalis eggs oviposited in guava juice-infused agar treated with coconut free fatty acid (CFA) at different doses relative to control (hexane) in two-choice bioassays. FIG. 1A shows data for 20 mg CFA/200 μL hexane/agar; FIG. 1B shows data for 2 mg CFA/200 μL hexane/agar; FIG. 1C shows data for 0.2 mg CFA/200 μL hexane/agar; FIG. 1D shows data for 0.02 mg/200 μL hexane/agar. For each test, different letters on bars indicate significant difference by Tukey-Kramer tests at P<0.05, n=6.

FIG. 2A to FIG. 2I depict graphs of the number (mean±SEM) of B. dorsalis eggs oviposited in guava juice-infused agar treated with individual components of coconut free fatty acid relative to control in two-choice bioassays. FIG. 2A shows data for C18:1 at 20 mg CFA/200 μL hexane/agar, n=6; FIG. 2B data for C18:1 at 2 mg CFA/200 μL hexane/agar, n=5; FIG. 2C shows data for C18:1 at 0.2 mg CFA/200 μL hexane/agar, n=5; FIG. 2D shows data for C18:2 at 20 mg CFA/200 μL hexane/agar, n=6; FIG. 2E shows data for C18:2 at 2 mg CFA/200 μL hexane/agar, n=5; FIG. 2F shows data for C18:2 at 0.2 mg CFA/200 μL hexane/agar, n=5; FIG. 2G shows data for C8 at 20 mg CFA/200 μL hexane/agar, n=6; FIG. 2H shows data for C8 at 2 mg CFA/200 μL hexane/agar, n=5; FIG. 2I shows data for C8 at 0.2 mg CFA/200 μL hexane/agar n=4; FIG. 2J shows data for C10 at 20 mg CFA/200 μL hexane/agar, n=6; FIG. 2K shows data for C8 at 2 mg CFA/200 μL hexane/agar, n=5; FIG. 2L shows data for C12 at 20 mg CFA/200 μL hexane/agar, n=6; FIG. 2M shows data for C14 at 20 mg CFA/200 μL hexane/agar, n=6; FIG. 2N shows data for C16 at 20 mg CFA/200 μL hexane/agar, n=6; FIG. 2O shows data for C18 at 20 mg CFA/200 μL hexane/agar, n=6. For each test, different letters on bar indicate significant difference by Tukey-Kramer tests at P<0.05, n=6 for FIG. 2A, FIG. 2D, FIG. 2G, FIG. 2J, FIG. 2L, FIG. 2M, FIG. 2N, FIG. 2O; n=5 for FIG. 2B, FIG. 2C, FIG. 2E, FIG. 2F, FIG. 2H, FIG. 2K; n=4 FOR FIG. 2I.

FIG. 3A to 3C depict graphs of the number (mean±SEM) of B. dorsalis eggs oviposited in guava juice-infused agar treated with hexane (control) or a 4-component blend (4c; OFF negative compounds) at three different doses in two-choice assays. FIG. 3A data for 2 mg coconut fatty acid (CFA) equivalent; FIG. 3B data for 0.2 mg CFA equivalent; FIG. 3C data for 0.02 mg CFA equivalent. For each test, different letters on bars indicate significant difference by Tukey-Kramer tests at P<0.05, n=4.

FIG. 4A to FIG. 4D depict graphs of the number (mean±SEM) of B. dorsalis eggs oviposited in two guava juice infused agars treated with either coconut free fatty acid (CFA) or an OFF negative control blend using two-choice assays. FIG. 4A CFA at 2 mg and 4-component blend (4c) at 2 mg CFA equivalent; FIG. 4B CFA at 0.2 mg and 4c at 0.2 mg CFA equivalent; FIG. 4C CFA at 2 mg and 6-component blend (6c) at 2 mg; FIG. 6D CFA at 0.2 mg and 6c at 0.2 mg CFA equivalent. For each test, different letters on bars indicate significant difference by Tukey-Kramer tests at P<0.05, n=4.

FIG. 5A and FIG. 5B depict graphs of the number (mean±SEM) of B. dorsalis eggs oviposited in two guava juice infused agars using two-choice assays. FIG. 5A agars treated with 6-component blend (6c) or a 6c minus lauric acid blend (5c-i) at 2 mg coconut free acid equivalent doses; FIG. 5B agars treated with 6c or a 6c minus myristic acid blend (5c-ii) at 2 mg coconut free acid equivalent doses. For each test, different letters on bars indicate significant difference by Tukey-Kramer tests at P<0.05, n=4.

FIG. 6 depicts a graph of the number (mean±SEM) of B. dorsalis eggs oviposited in guava juice infused agar after different treatments in no-choice bioassays. The Y axis shows the number of eggs per agar; The X axis shows the treatments hexane (control) or the 5-key deterrent component blend (5c-ii) at three different doses (20, 2, and 0.2 mg CFA equivalent). For each test, different letters on bars indicate significant difference by Tukey-Kramer tests at P<0.05, n=8.

FIG. 7A and FIG. 7B depict graphs of the numbers (mean±SEM) of B. dorsalis oviposited eggs and surviving larvae and pupae hatched from those eggs or in two-choice bioassays. FIG. 7A larvae and pupae reared out from papaya treated with hexane (control) or the 5-key deterrent component blend (5c-ii) at 2 mg CFA equivalent dose. FIG. 7B eggs oviposited in tomato treated with control or 5c-ii at 2 mg CFA equivalent dose. For each test, different letters on bars indicate significant difference by Tukey-Kramer tests at P<0.05, n=4.

FIG. 8A to FIG. 8E depict graphs of the number (mean±SEM) of B. dorsalis eggs oviposited in guava juice-infused agar treated with one of the five odd-numbered free fatty acids at 20 mg relative to control in a two-choice bioassay. FIG. 8A eggs oviposited in guava juice infused agar treated with C9:0; FIG. 8B eggs oviposited in guava juice infused agar treated with C11:07; FIG. 8C eggs oviposited in guava juice infused agar treated with C13:0; FIG. 8D eggs oviposited in guava juice infused agar treated with C15:0; FIG. 8E eggs oviposited in guava juice infused agar treated with C17:0. For each test, different letters on bars indicate significant difference by Tukey-Kramer tests at P<0.05, n=5.

FIG. 9 depicts a graph of the number (mean±SEM) of D. suzukii larvae and pupae reared out from raspberries treated with CFA or control hexane in the field. Different letters on bars indicate significant difference by Tukey-Kramer tests at P<0.05, N=15.

FIG. 10A to FIG. 10C depict graphs of the number (mean±SEM) of D. suzukii larvae and pupae reared out from raspberries in laboratory two-choice bioassays. FIG. 10A CFA at 20 mg/200 μl hexane/raspberry; FIG. 10B 2 mg/200 μl hexane/raspberry; FIG. 10C 0.2 mg/200 μl hexane/raspberry. For each test, different letters on bars indicate significant difference by Tukey-Kramer tests at P<0.05, N=4.

FIG. 11A to FIG. 11L depict graphs of the number (mean±SEM) of D. suzukii larvae and pupae reared out from raspberries treated with individual components of coconut free fatty acid relative to control in two-choice bioassays. FIG. 11A C8:0 at 20 mg per dose; FIG. 11B C8:0 at 2 mg per dose; FIG. 11C C8:0 at 0.2 mg per dose; FIG. 11D C10:0 at 20 mg per dose; FIG. 11E C10:0 at 2 mg per dose; FIG. 11F C10:0 at 0.2 mg per dose; FIG. 11G C12:0 at 20 mg per dose; FIG. 11H C14:0 at 20 mg per dose; FIG. 11I C16:0 at 20 mg per dose; FIG. 11J C18:0 at 20 mg per dose; FIG. 11K C18:1 at 20 mg per dose; FIG. 11L C18:2 at 20 mg per dose. For each test, different letters on bar indicate significant difference by Tukey-Kramer tests at P<0.05, N=4.

FIG. 12A to FIG. 12D depict graphs of the number (mean±SEM) of D. suzukii larvae and pupae reared out from raspberries treated with 2-component blend (2c) or control using two-choice bioassays. FIG. 12A treated with 2c or control at 20 mg CFA equivalent; FIG. 12B treated with 2c or control at 2 mg CFA equivalent; FIG. 12C treated with 2c or control at 0.2 mg CFA equivalent; FIG. 12D treated with 2 mg CFA or 2c at 2 mg CFA equivalent. For each test, different letters on bars indicate significant difference by Tukey-Kramer tests at P<0.05, N=4.

FIG. 13A and FIG. 13B depict graphs of the number (mean±SEM) of D. suzukii eggs oviposited and adults in treated raspberries. FIG. 123 eggs oviposited in treated raspberries in no-choice bioassays. Control: Hexane; C8:0: 20 mg C8:0 CFA equivalent doses; C10:0: 20 mg CFA equivalent doses; 20 mg C10:0 CFA equivalent doses; C8:0+C10:0: C_{8:0}+C_{10:0} 2-key-component deterrent blend 20 mg CFA equivalent doses. (N=8). FIG. 13B numbers of non-SWD drosophilid adults that emerged from four sentinel raspberries (4 raspberries/trap) treated with the same treatments as above, conducted in a guava orchard near Hilo, Hawaii (N=12). Different letters on bars indicate significant difference by Tukey-Kramer tests at P<0.05.

FIG. 14A to FIG. 14P depict the number (mean±SEM) of mated female B. dorsalis flies captured and B. dorsalis eggs oviposited in traps baited with guava juice with one of the even number carbon coconut fatty acid compound or guava juice alone (control). FIG. 14A shows the number of B. dorsalis captured and FIG. 14B shows the number of eggs oviposited in a trap baited with guava juice with C8 fatty acid (C8 acid); FIG. 14C shows the number of B. dorsalis captured and FIG. 14D shows the number of eggs oviposited in a trap baited with guava juice with C10 fatty acid (C10 acid); FIG. 14E shows the number of B. dorsalis captured and FIG. 14F shows the number of eggs oviposited in a trap baited with guava juice with C12 fatty acid (C12 acid); FIG. 14G shows the number of B. dorsalis captured and FIG. 14H shows the number of eggs oviposited in a trap baited with guava juice with C14 fatty acid (C14 acid); FIG. 14I shows the number of B. dorsalis captured and FIG. 14J shows the number of eggs oviposited in a trap baited with guava juice with C16 fatty acid (C16 acid); FIG. 14K shows the number of B. dorsalis captured and FIG. 14L shows the number of eggs oviposited in a trap baited with guava juice with C18 fatty acid (C18 acid); FIG. 14M shows the number of B. dorsalis captured and FIG. 14N shows the number of eggs oviposited in a trap baited with guava juice with C18:1 fatty acid (C18:1 acid); FIG. 14O shows the number of B. dorsalis captured and FIG. 14P shows the number of eggs oviposited in a trap baited with guava juice with C18:2 fatty acid (C18:2 acid). For each test, different letters on bar indicate significant difference by Tukey-Kramer tests at P<0.05. n=4.

FIG. 15A to FIG. 15L depict the number (mean±SEM) of mated female B. dorsalis flies captured and B. dorsalis eggs oviposited in traps baited with guava juice with one of the odd number carbon coconut fatty acid compound or guava juice alone (control). FIG. 15A shows the number of B. dorsalis captured and FIG. 15B shows the number of eggs oviposited in a trap baited with guava juice with C7 fatty acid (C7 acid); FIG. 5C shows the number of B. dorsalis captured and FIG. 15D shows the number of eggs oviposited in a trap baited with guava juice with C9 fatty acid (C9 acid); FIG. 15E shows the number of B. dorsalis captured and FIG. 15F shows the number of eggs oviposited in a trap baited with guava juice with C11 fatty acid (C11 acid); FIG. 15G shows the number of B. dorsalis captured and FIG. 15H shows the number of eggs oviposited in a trap baited with guava juice with C13 fatty acid (C13 acid); FIG. 15I shows the number of B. dorsalis captured and FIG. 15J shows the number of eggs oviposited in a trap baited with guava juice with C15 fatty acid (C15 acid); FIG. 15K shows the number of B. dorsalis captured and FIG. 15L shows the number of eggs oviposited in a trap baited with guava juice with C17 fatty acid (C17 acid). For each test, different letters on bar indicate significant difference by Tukey-Kramer tests at P<0.05. n=4.

FIG. 16A to FIG. 16T depict the number (mean±SEM) of mated female B. dorsalis flies captured and B. dorsalis eggs oviposited in traps baited with guava juice with one of the coconut fatty acid methyl esters or guava juice alone (control). FIG. 16A shows the number of B. dorsalis captured and FIG. 16B shows the number of eggs oviposited in a trap baited with guava juice with methyl caprylate (C8 Me); FIG. 16C shows the number of B. dorsalis captured and FIG. 16D shows the number of eggs oviposited in a trap baited with guava juice with methyl pelargonate (C9 Me); FIG. 16E shows the number of B. dorsalis captured and FIG. 16F shows the number of eggs oviposited in a trap baited with guava juice with methyl caprate (C10 Me); FIG. 16G shows the number of B. dorsalis captured and FIG. 16H shows the number of eggs oviposited in a trap baited with guava juice with methyl undecanoate (C11 Me); FIG. 16I shows the number of B. dorsalis captured and FIG. 16J shows the number of eggs oviposited in a trap baited with guava juice with methyl laurate (C12 Me); FIG. 16K shows the number of B. dorsalis captured and FIG. 16L shows the number of eggs oviposited in a trap baited with guava juice with methyl tridecanoate (C13 Me); FIG. 16M shows the number of B. dorsalis captured and FIG. 16N shows the number of eggs oviposited in a trap baited with guava juice with methyl myristate (C14 Me); FIG. 16O shows the number of B. dorsalis captured and FIG. 16P shows the number of eggs oviposited in a trap baited with guava juice with methyl pentadecanoate (C15 Me); FIG. 16Q shows the number of B. dorsalis captured and FIG. 16R shows the number of eggs oviposited in a trap baited with guava juice with methyl palmitate (C16 Me); FIG. 16S shows the number of B. dorsalis captured and FIG. 16T shows the number of eggs oviposited in a trap baited with guava juice with methyl heptadecanoate (C17 Me). For each test, different letters on bar indicate significant difference by Tukey-Kramer tests at P<0.05. n=4.

FIG. 17A to FIG. 17D depict the number (mean±SEM) of Z. cucurbitae eggs oviposited on pumpkin juice-infused agar treated with different amounts of CFFA in two-choice bioassays. FIG. 17A shows the number of eggs in control traps, and traps baited with CFFA at 20 mg/200 μL ethanol/agar dose. FIG. 17B shows the number of eggs in control traps, and traps baited with CFFA at 2 mg/200 μL ethanol/agar dose. FIG. 17C shows the number of eggs in control traps, and traps baited with CFFA at 0.2 mg/200 μL ethanol/agar dose. FIG. 17D shows the number of eggs in control traps, and traps baited with CFFA at 0.02 mg/200 μL ethanol/agar dose. Different letters on bars indicate significant differences at P<0.0001, n=10.

FIG. 18A to FIG. 18N depict the number (mean±SEM) of Z. cucurbitae eggs oviposited on pumpkin juice-infused agar treated with individual CFFA components in two-choice bioassays. FIG. 18A shows the number of eggs in control traps, and traps baited with C_{8:0} at 20 mg. FIG. 18B shows the number of eggs in control traps, and traps baited with C_{18:1} at 20 mg. FIG. 18C shows the number of eggs in control traps, and traps baited with C_{18:2} at 20 mg. FIG. 18D shows the number of eggs in control traps, and traps baited with C_{10:0} at 20 mg. FIG. 18E shows the number of eggs in control traps, and traps baited with C_{8:0} at 2 mg. FIG. 18F shows the number of eggs in control traps, and traps baited with C_{18:1} at 2 mg. FIG. 18G shows the number of eggs in control traps, and traps baited with C_{18:2} at 2 mg. FIG. 18H shows the number of eggs in control traps, and traps baited with C_{10:0} at 2 mg. FIG. 18I shows the number of eggs in control traps, and traps baited with C_{8:0} at 0.2 mg. FIG. 18J shows the number of eggs in control traps, and traps baited with C_{18:0} at 20 mg. FIG. 18K shows the number of eggs in control traps, and traps baited with C_{12:0} at 20 mg. FIG. 18L shows the number of eggs in control traps, and traps baited with C_{14:0} at 20 mg. FIG. 18M shows the number of eggs in control traps, and traps baited with C_{8:0} at 0.02 mg. FIG. 18N shows the number of eggs in control traps, and traps baited with C_{16:0} at 20 mg. Different letters on bars indicate significant differences at P<0.0001, n=10.

FIG. 19A to FIG. 19G depict the number (mean±SEM) of Z. cucurbitae eggs oviposited in pumpkin juice-infused agar treated with different CFFA component blends in a two choice bioassay. FIG. 19A shows the number of eggs in control traps and traps baited with the 4c blend at 2 mg CFFA equivalent dose. FIG. 19B shows the number of eggs in control traps and traps baited with 4c blend at 0.02 mg CFFA equivalent dose. FIG. 19C shows the number of eggs in control traps and traps baited with 5c blend at 2 mg CFFA equivalent dose. FIG. 19D shows the number of eggs in traps baited with 4c blend and traps baited with 5c blend at 2 mg CFFA equivalent dose. FIG. 19E shows the number of eggs in control traps, and traps baited with C_{8:0} at 2 mg CFFA equivalent dose. FIG. 19F shows the number of eggs in control traps, and traps baited with C_{18:1} at 2 mg CFFA equivalent dose. FIG. 19G shows the number of eggs in control traps, and traps baited with C_{18:2} at 2 mg CFFA equivalent dose.

FIG. 20A and FIG. 20B depict the number (mean±SEM) of Z. cucurbitae eggs oviposited in pumpkin juice or the number of pupae reared out from cucumbers. FIG. 20A shows the number of eggs oviposited in pumpkin juice-infused agar treated with ethanol (control) or with the 5ciii blend at 2 mg CFFA equivalent dose in no-choice bioassays. FIG. 20B shows the number of pupae reared out from cucumbers treated with the 5ciii blend at 2 mg CFFA equivalent dose relative to ethanol control. Different letters on bars indicate significant differences at P<0.0001, n=10.

FIG. 21A to FIG. 21D depict results from behavior tracking analysis of Z. cucurbitae movement in an experimental arena in two-choice bioassay with control and 5ciii blend treated (2 mg CFFA equivalent) zones. FIG. 21A shows a heatmap analysis of Z. cucurbitae movement in the experimental arena. FIG. 21B shows the cumulative duration in each zone. FIG. 21C shows the number of eggs in each zone. FIG. 21D shows the number of visits per zone. Data are represented as mean±SEM. Different letters on bars indicate significant differences at P<0.0001, n=25.

FIG. 22A to FIG. 22J depict the number (mean±SEM) of Z. cucurbitae eggs oviposited on pumpkin juice-infused agar treated with individual fatty acid components at 20 mg/200 μL ethanol/agar doses relative to control (ethanol) in two-choice bioassays. FIG. 22A shows the number of eggs in trap baited with C_{5:0}. FIG. 22B shows the number of eggs in trap baited with C_{11:0}. FIG. 22C shows the number of eggs in trap baited with C_{13:0}. FIG. 22D shows the number of eggs in trap baited with C_{6:0}. FIG. 22E shows the number of eggs in trap baited with C_{7:0}. FIG. 22F shows the number of eggs in trap baited with C_{15:0}. FIG. 22G shows the number of eggs in trap baited with C_{17:0}. FIG. 22H shows the number of eggs in trap baited with C_{4:0}. FIG. 22I shows the number of eggs in trap baited with C_{9:0}. FIG. 22J shows the number of eggs in trap baited with C_{19:0}. Different letters on bars indicate significant differences at P<0.0001, n=5.

FIG. 23A to FIG. 23D depict the number (mean±SEM) of B. dorsalis eggs oviposited on pumpkin juice-infused agar treated with individual fatty acid components at 20 mg/200 μL ethanol/agar doses relative to control (ethanol) in two-choice bioassays. FIG. 23A shows the number of eggs in trap baited with C_{4:0}. FIG. 23B shows the number of eggs in trap baited with C_{5:0}. FIG. 23C shows the number of eggs in trap baited with C_{6:0}. FIG. 23D shows the number of eggs in trap baited with C_{7:0}. Different letters on bars indicate significant differences at P<0.0001, n=5.

FIG. 24A to FIG. 24H depict the number (mean±SEM) of Z. cucurbitae flies captured in traps baited with individual fatty acid methyl ester (FAME) components at 100 μL doses relative to control in two-choice bioassays. FIG. 24A shows the number of flies captured in trap baited with C_{8:0}ME. FIG. 24B shows the number of flies captured in trap baited with C_{10:0}ME. FIG. 24C shows the number of flies captured in trap baited with C_{12:0}ME. FIG. 24D shows the number of flies captured in trap baited with C_{18:1}ME. FIG. 24E shows the number of flies captured in trap baited with C_{16:0}ME. FIG. 24F shows the number of flies captured in trap baited with C_{18:0}ME. FIG. 24G shows the number of flies captured in trap baited with C_{14:0}ME. FIG. 24H shows the number of flies captured in trap baited with C_{18:2}ME. Different letters on bars indicate significant differences at P<0.0001, n=5.

### DETAILED DESCRIPTION

The present disclosure relates to fruit fly oviposition deterrent compositions comprising at least two coconut free fatty acids (CFA), caprylic acid (C8:0) and capric acid (C10:0). The compositions may comprise at least one other CFA such as oleic acid (C18:1), linoleic acid (C18:2), myristic acid (C14:0), or lauric acid (C12:0).

The inventors have explored the oviposition-deterrent properties of coconut free fatty acids (CFA) that have relatively low vapor pressure (<0.0038 mm Hg at 25° C.). CFA is a mixture of four medium-chain length free fatty acid compounds [caprylic acid (C8:0), capric acid (C10:0), lauric acid (C12:0), and myristic acid (C14:0)] and four long-chain length free fatty acid compounds [palmitic acid (C16:0), stearic acid (C18:0), oleic acid (C18:1) and linoleic acid (C18:2)] derived from coconut oil. The medium-chain length acid compounds have been shown to have strong deterrent activity to several blood-sucking arthropods such as mosquitoes, ticks, biting flies, and bed bugs in terms of feeding and oviposition (Zhu J J et al., supra). Whether CFA is effective for controlling fruit damage from fruit flies has not been previously evaluated.

Using laboratory choice- and no-choice assays, and field oviposition experiments, the inventors have: 1) determined oviposition deterrent efficacies of CFA and its eight individual components on drosophilid and tephritid oviposition at different doses; 2) identified key bioactive oviposition-deterrent components for drosophilids and tephritids; and 3) evaluated the efficacy of key component blends as oviposition-deterrents of SWD in its preferred host, raspberry, and two known OFF host fruits (papaya and tomato).

The antagonistic nature of CFA appears to be widespread among insects. The effect was first reported for blood-sucking insects (Zhu J J et al., 2018, supra). The inventors surprisingly show that CFA also has an antagonistic impact on fruit infesting drosophilids and tephritid. Although the mode of action by which CFA reduces biting from blood-sucking insects or oviposition from drosophilids and tephritids remains to be understood, with the relatively low vapor pressure of CFA compounds (all <0.0038 mmHg at 25° C.), it is anticipated that the behavioral mode of CFA-based antagonism may be more contact-based than spatially-based. However, it is also possible that CFA has a spatial effect on insect response. For example, electroantennography indicated that some chemicals from CFA could be detected by the antennae of stable flies; moreover, laboratory bioassays demonstrated that the addition of CFA to 1-octen-3-ol (a known stable fly attractant) resulted in behavioral inhibition in fly orientation toward the attractant source, suggesting the potential for spatially-mediated effects.

All eight CFA components, including the five OFF key-oviposition deterrent compounds for OFF, are naturally occurring, readily biodegradable, and generally regarded as safe to humans with known presence in fruits, fruit seed oil, and foodstuff. Therefore, the potential exists to develop CFA or some of its component compounds as environmentally sound sprayable formulations for controlling OFF. In fact, similar groups of chemicals are already commercially available as a safer alternative to synthetic insecticides to control agricultural pests. For example, Safer Insecticidal Soap™ technology appears to be based on longer chain mono alpha carboxylic acids with C16 to C18 components as the main active ingredients. Although further studies are needed to assess the effect of the deterrent blend on fruit quality, the inventors' initial observations indicate no apparent damage to tomato leaves or fruits from the treatment, while there was some browning observed with papaya fruit. However, similar levels of browning were observed in papayas treated with the hexane control. Therefore, it is not clear if the browning was due to the CFA compounds or simply the hexane solvent. Currently, we are working with an industry to develop prototype solventless formulations to test potential effects of CFA compounds on fruit quality. Several fatty acid compounds have also been used as the main components of antifeedant and oviposition deterrents for blood-sucking insects (Hwang Y S et al., 1982, “Ovipositional repellency of fatty acids and their derivatives against Culex and Aedes mosquitoes, Environ. Entomol. 11: 223-226; Ali A et al., 2012, “Aedes aegypti (Diptera: Culicidae) Biting deterrence: structure activity relationship of saturated and unsaturated fatty acids,” J. Med. Entomol. 49:1370-1378; Zhu et al., 2018, supra) and insecticides for stored product pests.

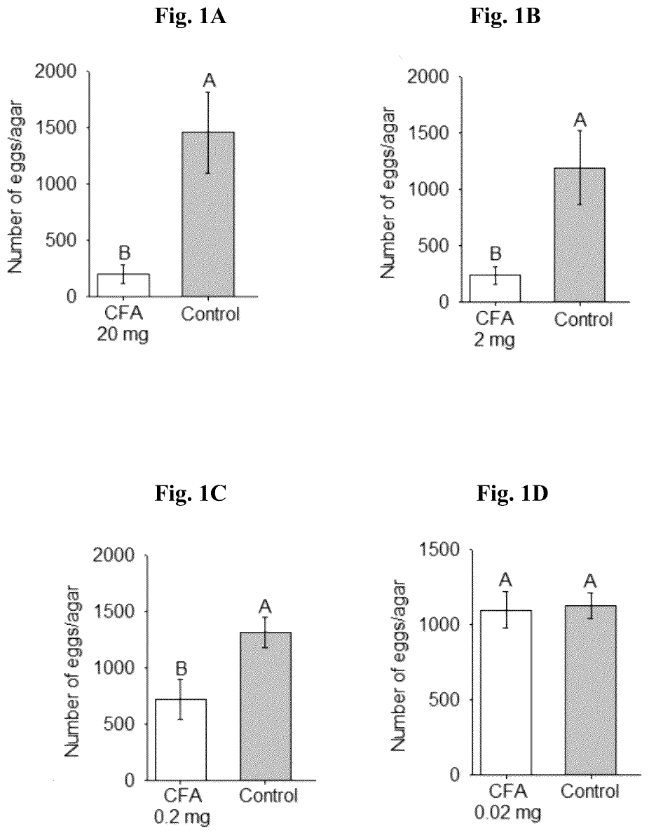

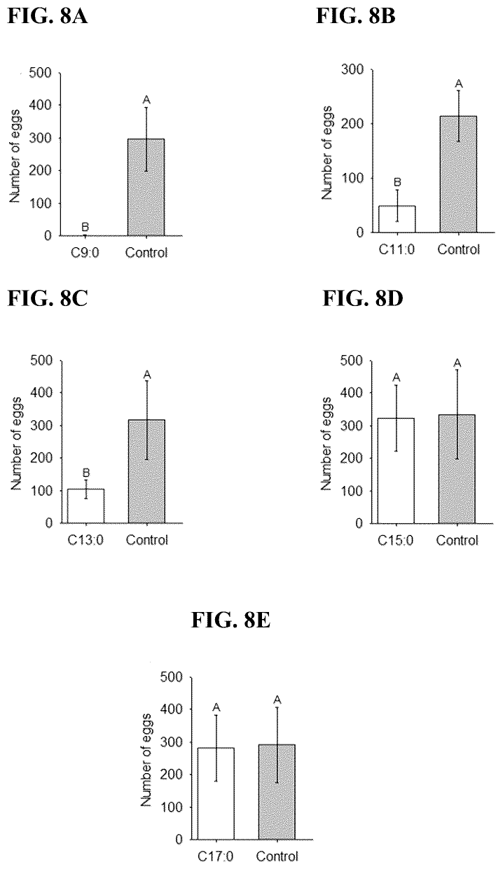

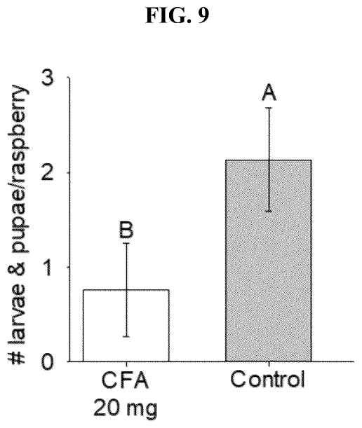

As seen in FIG. 1A to FIG. 1D, CFA presented strong OFF oviposition deterrence when compared to the effect of hexane control when used at 20 mg equivalent dose and 2 mg equivalent dose. Similarly, FIG. 8 shows that CFA at 20 mg presents SWD oviposition deterrence as compared to hexane control in raspberries treated in the field. As seen in FIG. 9A to FIG. 9C the CFA SWD oviposition deterrence in the laboratory is concentration-dependent.

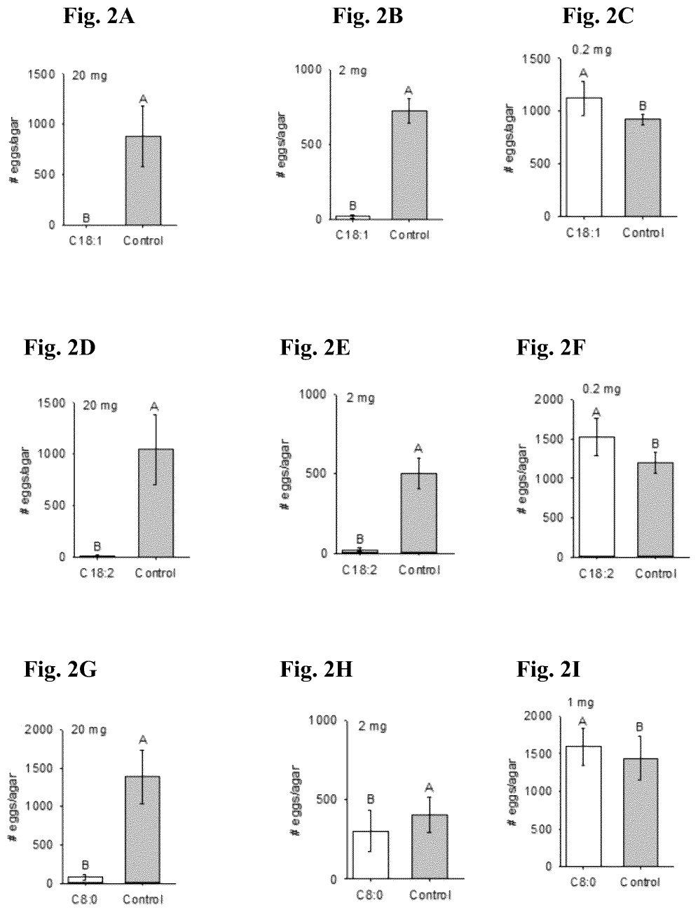

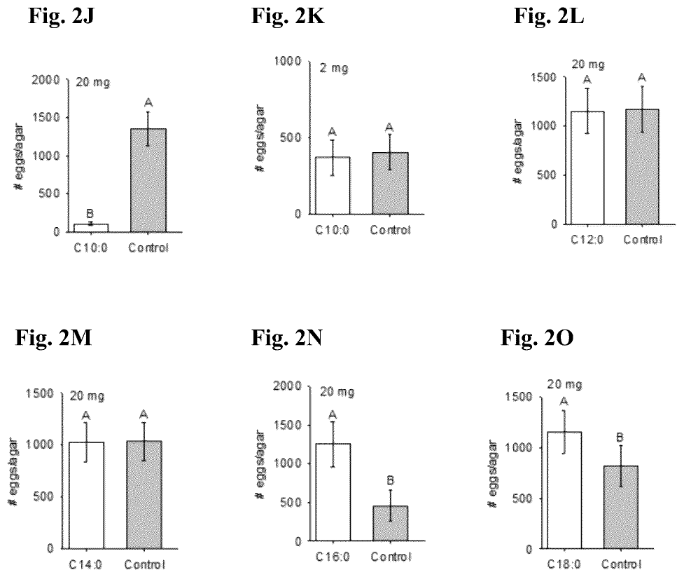

Surprisingly, the inventors observed a stronger OFF oviposition deterrence with the saturated medium-chain fatty acids (C8:0 and C10:0) and unsaturated long-chain fatty acids (C18:1 acid=cis-9:18 Acid (oleic acid) and C18:2 acid=cis-9,12:18 Acid (linoleic acid) as shown below) than with the saturated longer chain length acids (C14:0, C16: 0, C18:0). This data is shown in FIG. 2A through FIG. 2O. For mosquitoes and stable flies, with medium-chain length acids showing strong antifeedant activity but no activity from longer chain length acids. Among the four “OFF negative” compounds that elicited decreased oviposition in OFF when presented individually, the two unsaturated fatty acids (C18:1 and C18:2) appeared to have greater oviposition deterrent activity than the saturated chain fatty acids (C8:0 and C10:0) with much greater oviposition reduction when tested at the 2 mg dose.

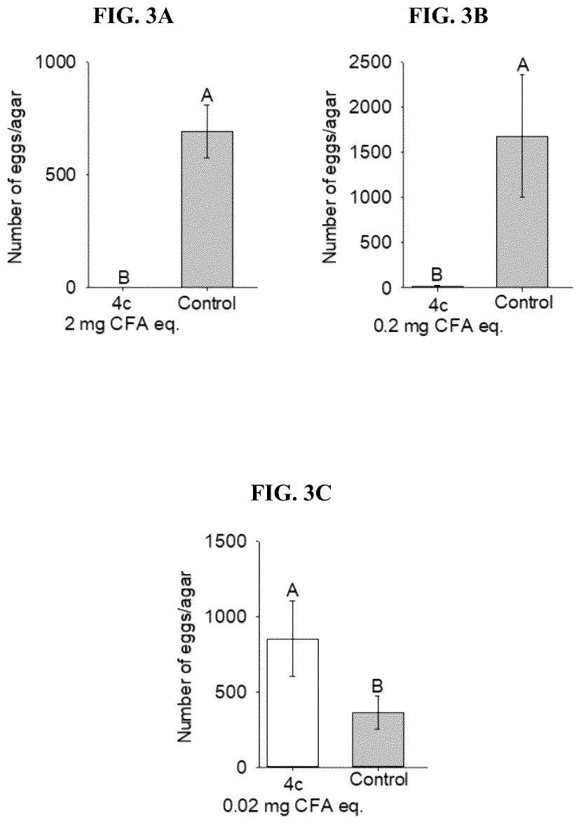

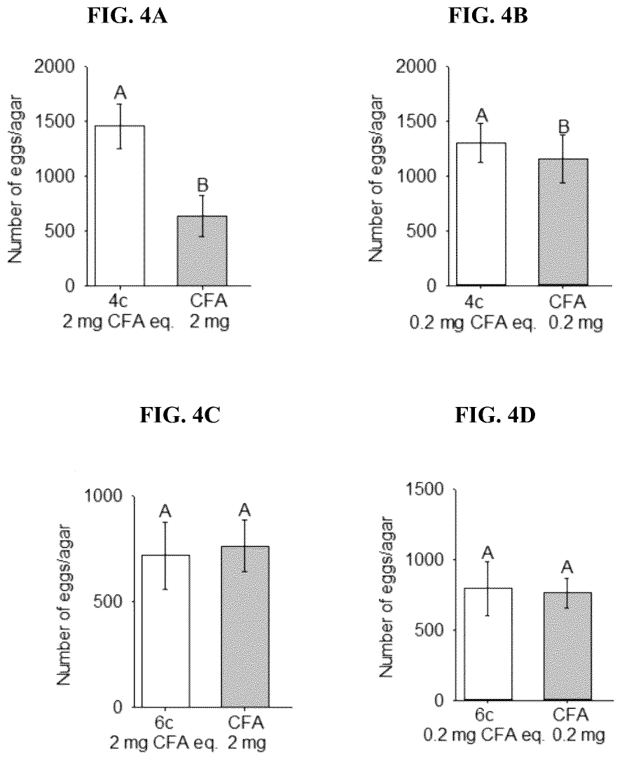

The inventors tested the deterrence of OFF oviposition in the laboratory using hexane (control) or a four component blend containing caprylic acid (C8:0), capric acid (C10:0), oleic acid (C:18:1), and linoleic acid (C18:2) (4c, Table 1). As seen in FIG. 3A to FIG. 3C, this 4c blend presented great oviposition deterrence when used at 2 mg CFA dose equivalent or at 0.2 mg CFA dose equivalent. FIG. 4A shows that in a laboratory assay 2 mg of CFA has better oviposition deterrence than the 4c blend at equivalent dose. FIG. 4B shows that the OFF oviposition deterrence is less at a lower dose. FIG. 4C and FIG. 4D show that the OFF oviposition deterrence by CFA at 2 mg and 0.2 mg is similar to the deterrence by the six component blend (caprylic acid (C8:0), capric acid (C10:0), lauric acid (C12:0), myristic acid (C14:0), oleic acid (C18:1), and linoleic acid (C18:2)) at 2 mg and at 0.2 mg CFA-equivalent.

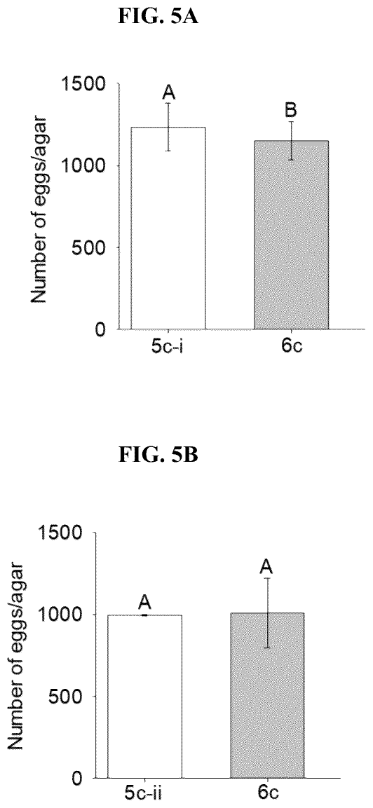

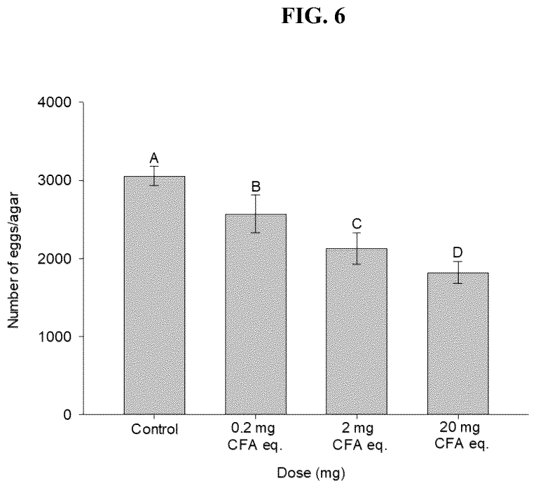

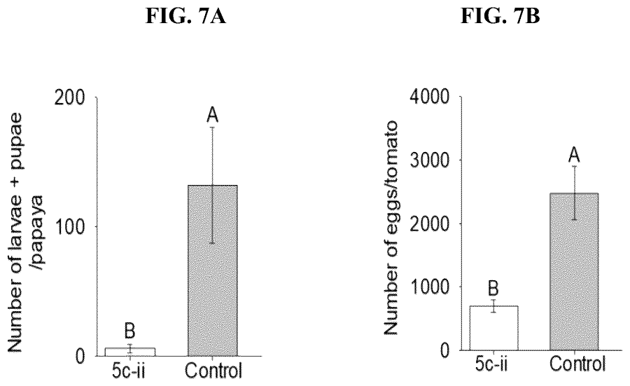

As seen in FIG. 5A, a five component blend, 5c-i, comprising caprylic acid (C8:0), capric acid (C10:0), myristic acid (C14:0), oleic acid (C18:1), and linoleic acid (C18:2) did not deter OFF oviposition as well as the six component blend (6c). But, as seen in FIG. 5B, a five component blend, comprising caprylic acid (C8:0), capric acid (C10:0), lauric acid (C12:0), oleic acid (C18:1), and linoleic acid (C18:2), 5c-ii was about as efficacious as the six component blend. The data in FIG. 6 shows that under a no-choice setting the 5c-ii blend showed significant oviposition deterrence against OFF. FIG. 7 shows that the 5c-ii key component blend was effective at reducing OFF oviposition on OFF host fruits papaya and grape tomato.

Thus, the inventors have identified a blend of five key CFA components (5c-ii blend; caprylic acid, capric acid, lauric acid, oleic acid, and linoleic acid; Table 1) that exhibited consistent oviposition deterrent effects on mated female OFF. This blend elicited a similar level of reduction in OFF oviposition as CFA, the original deterrent material composed of eight coconut free fatty acids derived from coconut oil, at the equivalent ratio and concentration in CFA. The oviposition deterrent activity was observed consistently both in no-choice and choice assays. Under the 3-day no-choice tests, the 5-key-component blend resulted in significant reductions in OFF oviposition on guava juice-infused agar. Within the range of doses tested (20, 2, and 0.2 mg CFA equivalent/agar), there was a linear dose-dependent decrease in oviposition with increasing treatment dose. The blend was also effective at reducing OFF oviposition in two host fruits. When applied on papaya and tomato, the 5c-ii blend at the 2 mg CFA equivalent dose, shown effective on the artificial oviposition substrate, significantly reduced OFF oviposition on those host fruit. Given the consistent biological activities of the 5-key-component blend on artificial oviposition substrate and host fruit in choice/no-choice experiments, the results support a strong oviposition deterrent effect of the OFF key-component blend.

These results show that the 5-key-component blend (5c-ii) is a promising oviposition deterrent of OFF that could be used as an alternative tool to sustainably manage invading OFF populations. The oviposition deterrent could provide OFF management programs a means to proactively protect fruit before, during, and after quarantine. It could also allow for preparation for the undesirable event of establishment of these flies that can constitute serious trade-barrier.

It could be used at packing houses or when harvested host material needs to pass through quarantine zones as an additional safeguarding measure. The oviposition deterrent could also be a valuable tool for growers producing OFF-susceptible fruit crops in OFF native or established regions as an alternative treatment option to insecticides or bait sprays showing resistance development.

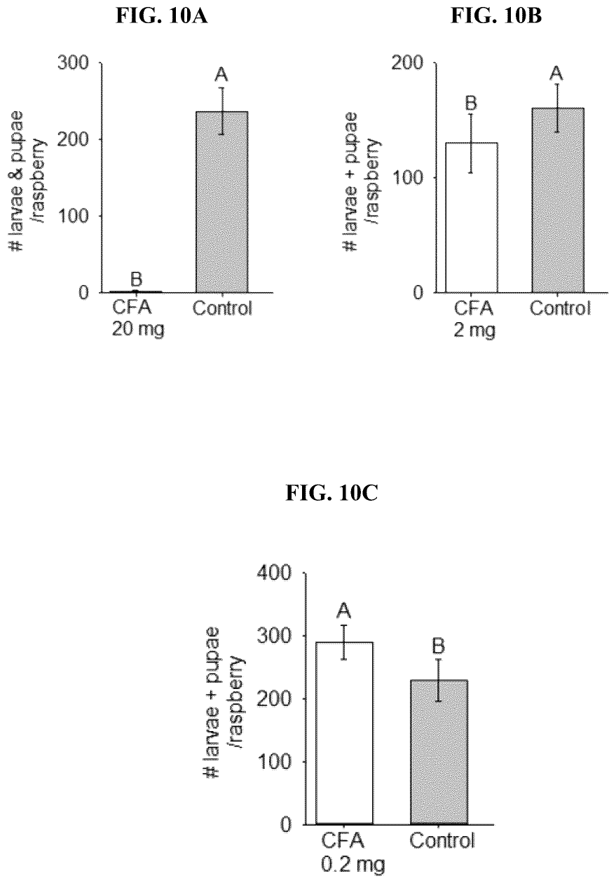

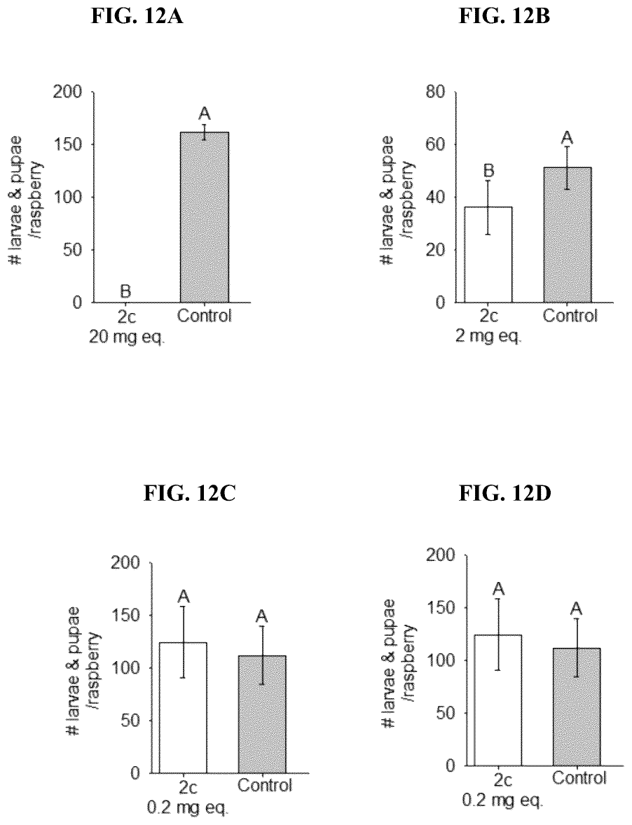

As mentioned above, the results presented here show that a mixture of eight even-numbered carbon free fatty acids (C8 to C18) derived from coconut oil, is an effective oviposition deterrent for SWD. Within the tested dose ranges from 0.2 to 20 mg of CFA, SWD oviposition was reduced in a dose-dependent manner. Moreover, C8:0 and C10:0 are the 2-key-components that explain the oviposition deterrence of CFA against SWD. As seen in FIG. 10A to FIG. 10L, C8:0 and C10:0 were effective at reducing SWD oviposition by themselves but appeared to be less effective compared to when they were combined as a blend (2c blend; FIG. 12A), suggesting some additive or synergistic response. The 2c blend, at equivalent CFA concentrations, consistently showed a similar level of oviposition deterrence as the CFA for both SWD and non-SWD drosophilids.

Although to the inventors' knowledge, this is the first report of the strong oviposition deterrent properties of CFA on fruit-infesting flies, the antagonistic nature of various fatty acid compounds has been well documented and appears to be widespread among a broad array of hematophagous and phytophagous insects. For phytophagous insects, it has been shown that some fatty acid compounds have oviposition deterrent effects on Delia radicum L. (Cole R A et al., 1989,” Deterrent effect of carboxylic acid on cabbage root fly oviposition,” Ann. Appl. Biol. 115: 39-44), Ostrinia furnacacalis Guenée (Guo L and Li G Q, 2009,” Olfactory perception of oviposition-deterring fatty acids and their methyl esters by the Asian corn borer, Ostrinia furnacalis,” J. Insect Sci. 9: 67), and Bemisia tabaci Gennadius and Myzus persicae Sulzer (Cruz-Estrada A et al., 2019, “Medium-chain fatty acids from Eugenia winzerlingii leaves causing insect settling deterrent, nematicidal, and phytotoxic effects,” Molecules 24:1724). For hematophagous insects, strong repellent activities of CFA have been shown against a broad array of blood-sucking arthropods, including biting flies, bed bugs, ticks and mosquitoes. These studies also show that different insect species respond to different components of CFA, suggesting different insect species may respond to different bioactive compounds. Results from the non-target drosophilids field experiment also indirectly supports this. Although both C_{8:0} and C_{10:0} were effective at reducing SWD oviposition as individual compounds, C_{8:0} and C_{10:0} as individual compounds appeared to be not effective at deterring oviposition from non-SWD drosophilids. This is also true for some tephritid fruit flies. For example, the data shown here on the effect of CFA on tropical fruit flies (Tephritidae) suggests that Bactrocera dorsalis, oriental fruit fly, requires 5-key-compounds among the eight CFA compounds to exert the same level of oviposition deterrence as CFA.

The inventors observed stronger oviposition deterrence with the saturated medium-chain fatty acids (C8:0 and C10:0) than with the longer chain length fatty acids (C12:0, C14:0, C16:0, C18:0, C18:1 and C18:2). Similar results have been reported for mosquitoes and stable flies, with medium-chain length fatty acids showing higher antifeedant activity than longer chain length fatty acids. However, C12 acid is a strong antifeedant against blood-suck insects. The behavioral mode of oviposition reduction by CFA compounds, i.e., spatially-mediated or contact-mediated, remains to be determined. Although CFA compounds have generally low volatility (all <0.0038 mmHg at 25° C.), it has been shown that some of the CFA components can be detected by insect antennae.

These CFA compounds are naturally occurring, readily biodegradable, and generally regarded as safe to humans with presence in fruits, fruit seed oil, and foodstuff. Given the consistent oviposition deterrence and safety of the 2-key-component blend and CFA, there is excellent potential to use these chemicals as a behavioral controlling agent for fruit files and other pests of food crops. For example, there are currently some alternative pest control products available for consumers based on similar groups of chemicals such as insecticidal soaps. In particular, Safer Insecticidal Soap™ technology appears to be based on longer chain mono alpha carboxylic acids with C16 to C18 components as the main active ingredients.

The 2-key-deterrent-component blend of C8:0 and C10:0 is a promising SWD oviposition deterrent and has the potential to be used to sustainably reduce SWD damage in commercial fruit operations. Given their low volatility, they are not likely to rapidly dissipate from the crop after application and therefore may provide residual deterrent activity over multiple days, a distinct practical advantage compared to more volatile repellent compounds that require potentially more frequent release into the environment. Overreliance on insecticides in managing SWD is problematic due to the associated economic and environmental costs, risks of insecticide resistance, and disruption of established IPM programs. The soft fruit industry needs alternative approaches for managing SWD to reduce reliance on insecticides. The inventors believe that the 2-component oviposition deterrent blend could be used as a basis for a novel management tactic, potentially in combination with other approaches such as attract-and-kill technology, to reduce SWD infestations and overall insecticide use in berries and other susceptible crops.

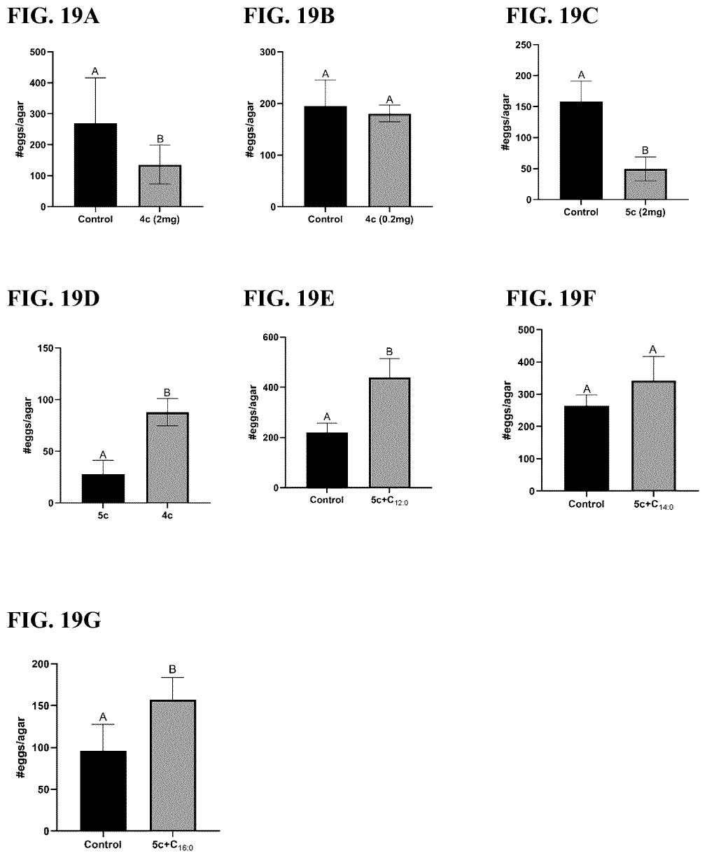

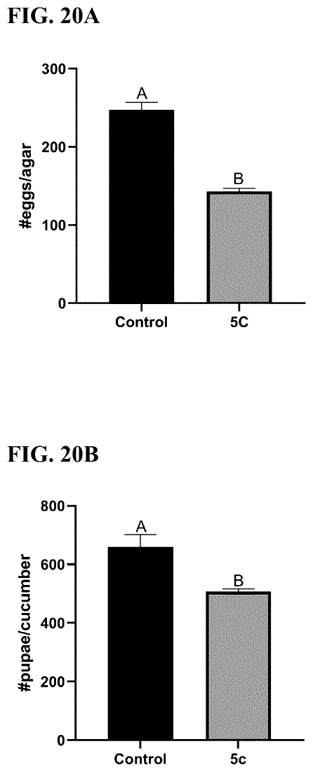

The data disclosed here demonstrates that a blend of five CFFA components (5c-iii; caprylic acid, capric acid, stearic acid, oleic acid, and linoleic acid) has consistent oviposition deterrent effects on mated female Z. cucurbitae. The data shows that Z. cucurbitae females oviposit significantly fewer eggs on artificial oviposition substrate surface treated with the 5c-iii blend in both choice (FIG. 19C) and no-choice bioassays (FIG. 20A) and on 5c-iii-treated cucumber (FIG. 20B). The data also shows that at the concentrations tested in this study, Z. cucurbitae made fewer visits to the 5c-iii treated agar and, once visited, stayed for a significantly shorter duration on the 5c-iii treated agar, suggesting that the behavioral mode of CFFA mediated oviposition deterrence on Z. cucurbitae may be the combination of spatial repellence and contact deterrence at the concentration of the 5c-iii tested in this study. Deterrents are best described in terms of their effects on specific behaviors, such as oviposition (Kennedy J S, 1947, “The excitant and repellent effects on mosquitoes of sub-lethal contacts with DDT,” Bull. Entomol. Res. 37: 593-607; Dethier V G et al., 1960, “The designation of chemicals in terms of the responses they elicit from insects,” J. Econ. Entomol. 53: 134-136; Miller J R et al., 2009, “Designation of chemicals in terms of the locomotor responses they elicit from insects. An update of Dethier et al. (1960),” J. Econ. Entomol. 102: 2056-2060) while repellence is spatially mediated and defined as the effect of stimulus on spatial distribution of the organism (Deletre E et al., 2016, “Prospects for repellent in pest control: current developments and future challenges,” Chemoecology 26: 127; Wallingford A K et al., 2017, “Robust Manipulations of Pest Insect Behavior Using Repellents and Practical Application for Integrated Pest Management,” Environ. Entomol. 46(5):1041-1050). The results presented, in concert with the findings of Roh G H et al (2020, “Spatial repellency, antifeedant activity and toxicity of three medium chain fatty acids and their methyl esters of coconut fatty acid against stable flies,” Pest Manag. Sci. 76: 405-414; 2023, “Coconut oil derived five-component synthetic oviposition deterrent for oriental fruit fly, Bactrocera dorsalis,” Pest Manag. Sci. 79(10):3852-3859), suggest that CFFA compounds are promising sources for oviposition deterrents for different fruit flies and other insects (Zhu et al., 2016; Supra).

Although oviposition deterrence of CFFA appears widespread among fruit flies and other insects (Roh et al., 2023, Supra; Zhu et al., 2018, Supra), studies have suggested that different insect species cue on different CFFA components as their key oviposition deterrents. Roh et al. (2023, Supra) reported that D. suzukii uses 2-components (C_{8:0}, and C_{10:0}) of CFFA mixture and B. dorsalis uses 5-components (C_{8:0}, C_{10:0}, C_{12:0}, C_{18:1}, and C_{18:2}). Although CFFA stimulated Z. cucurbitae oviposition, 5-components (C_{8:0}, C_{10:0}, C_{18:0}, C_{18:1}, and C_{18:1}; Table 1) of CFFA were identified in the present study as the key deterrent components that resulted in 76.4% reduction in oviposition by Z. cucurbitae at 2 mg CFFA equivalent dose (FIG. 19C), which was one compound (C_{18:0}) different than the 5-component key oviposition deterrent than B. dorsalis (Roh et al., 2023, Supra). This indicates that there are plasticity among different fruit flies in how they perceive deterrents and that there is a need to identify key oviposition deterrent components for different fruit flies for the practical application of these oviposition deterrents for the management fruit flies.

The five key oviposition deterrent compounds identified in the present study are generally regarded as safe and naturally occurring with known presence in fruits and vegetable oils

Unless otherwise explained, all technical and scientific terms used herein have the same meaning as commonly understood by one of ordinary skill in the art to which this disclosure belongs. The singular terms “a”, “an”, and “the” include plural referents unless context clearly indicates otherwise. Similarly, the word “or” is intended to include “and” unless the context clearly indicate otherwise.

As used herein, the term “about” is defined as plus or minus ten percent of a recited value. For example, about 1.0 g means 0.9 g to 1.1 g.

As used herein, the term “4c blend” relates to a blend of f our OFF-negative fatty acid compounds C8:0, C10:0, C18:1 and C18:2.

As used herein, the term “5c-i blend” refers to a blend of C8:0, C10:0, C14:0, C18:1, and C18:2.

As used herein, the term “5c-ii blend” refers to a blend of C8:0, C10:0, C12:0, C18:1, and C18:2.

As used herein, the term “5c-iii blend” refers to a blend of C8:0, C10:0, C18:0, C18:1, and C18:2.

As used herein, the term “6c blend” refers to a blend of C8:0, C10:0, C18:0, C14:0, C18:1, and C18:2.

Mention of trade names or commercial products in this disclosure is solely for the purpose of providing specific information and does not imply recommendation or endorsement by the U.S. Department of Agriculture.

Embodiments of the present disclosure are shown and described herein. It will be obvious to those skilled in the art that such embodiments are provided by way of example only. Numerous variations, changes, and substitutions will occur to those skilled in the art without departing from the disclosure. Various alternatives to the embodiments of the disclosure described herein may be employed in practicing the disclosure. It is intended that the included claims define the scope of the disclosure and that methods and structures within the scope of these claims and their equivalents are covered thereby. All publications, patents, and patent applications mentioned in this specification are herein incorporated by reference to the same extent as if each individual publication, patent, or patent application was specifically and individually indicated to be incorporated by reference.

The amounts, percentages and ranges disclosed herein are not meant to be limiting, and increments between the recited amounts, percentages and ranges are specifically envisioned as part of the invention. All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10 including all integer values and decimal values; that is, all subranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

The term “consisting essentially of” excludes additional method (or process) steps or composition components that substantially interfere with the intended activity of the method (or process) or composition, and can be readily determined by those skilled in the art (for example, from a consideration of this disclosure or practice of the material disclosed herein).

According to MPEP 2173.05(i), the current view of the courts is that there is nothing inherently ambiguous or uncertain about a negative limitation. So long as the boundaries of the patent protection sought are set forth definitely, albeit negatively, the claim complies with the requirements of 35 U.S.C. 112(b) or pre-AIA 35 U.S.C. 112, second paragraph.

Any negative limitation or exclusionary proviso must have basis in the original disclosure. If alternative elements are positively recited in the specification, they may be explicitly excluded in the claims. See In re Johnson, 558 F.2d 1008, 1019, 194 USPQ 187, 196 (CCPA 1977) (“[the] specification, having described the whole, necessarily described the part remaining.”). See also Ex parte Grasselli, 231 USPQ 393 (Bd. App. 1983), aff'd mem., 738 F.2d 453 (Fed. Cir. 1984). In describing alternative features, the applicant need not articulate advantages or disadvantages of each feature in order to later exclude the alternative features. See Inphi Corporation v. Netlist, Inc., 805 F.3d 1350, 1356-57, 116 USPQ2d 2006, 2010-11 (Fed. Cir. 2015). The mere absence of a positive recitation is not basis for an exclusion. However, a lack of literal basis in the specification for a negative limitation may not be sufficient to establish a prima facie case for lack of descriptive support. Ex parte Parks, 30 USPQ2d 1234, 1236 (Bd. Pat. App. & Inter. 1993). “Rather, as with positive limitations, the disclosure must only ‘reasonably convey[ ] to those skilled in the art that the inventor had possession of the claimed subject matter as of the filing date.’ . . . While silence will not generally suffice to support a negative claim limitation, there may be circumstances in which it can be established that a skilled artisan would understand a negative limitation to necessarily be present in a disclosure.” Novartis Pharms. Corp. v. Accord Healthcare, Inc., 38 F.4th 1013, 2022 USPQ2d 569 (Fed. Cir. 2022) (quoting Ariad Pharm. Inc. v. Eli Lilly & Co., 589 F.3d 1336, 1351, 94 USPQ2d 1161, 1172).

### EXAMPLES

Having now generally described this disclosure, the same will be better understood by reference to certain specific examples, which are included herein only to further illustrate the disclosure and are not intended to limit the scope of the disclosure as defined by the claims.

### Example 1

### Materials and Methods

The materials and methods used in the development of biocontrol compositions that deter fruit fly oviposition reducing infestation of these fruit flies on their preferred host fruits, kits comprising such compositions, and methods of using such compositions to reduce fruit fly populations are described herein.

Insects: Adult oriental fruit flies (OFF) were eclosed from pupae obtained from an OFF colony maintained on a standard larval diet containing wheat, sugar, and yeast (Tanaka N, et al., 1969, “Low-cost larval rearing medium for mass production of Oriental and Mediterranean fruit flies,” J. Econ. Entomol. 62: 967-968) at the U. S. Pacific Basin Agricultural Research Center in Hilo, Hawaii, USA. Cohorts of eclosed 1-to 2-day-old male and female flies were held for 12 to 18 days in screened cages (30 cm W×30 cm L×30 cm H; BUGDORM-2120 Insect rearing tent; shop.bugdorm.com) and provisioned with sugar and protein hydrolysate as food at 24° C., 55 to 60% relative humidity, and 12L:12D photoperiod until used in oviposition bioassays.

Spotted wing Drosophila (SWD) flies used in the experiments were from colonies maintained at two locations: U. S. Pacific Basin Agricultural Research Center in Hilo, Hawaii, USA and Cornell AgriTech, Geneva, New York, USA as described in Cha D K et al. (2021, “2-Pentylfuran: a novel repellent of Drosophila suzukii,” Pest Manage Sci. 77: 1757-1764). The Hawaii colony flies were originally reared out from strawberry guava fruit (Psidium cattleyanum Sabine) collected near Hilo, in 2020 and maintained at 22.1±1.9° C., 71.7±3.1% RH, 16:8 L:D on Drosophila medium (Carolina Biological Supply Co., Burlington, North Carolina, USA) with brewer's yeast (ACH Foods; Ankeny, Iowa, USA). The Cornell AgriTech colony was established from wild SWD captured with live traps near Geneva, New York during 2018 and reared at 25° C., 55% RH, 16:8 L:D on standard cornmeal diet [1 L distilled water, 40 g sucrose, 25 g cornmeal (Quaker Oats Co.; Chicago, Illinois, USA), 9 g agar (No. 7060; Frontier Agricultural Sciences, Newark, Delaware, USA), 14 g torula yeast (No. 1720; Frontier Agricultural Sciences, Newark, Delaware, USA), 3 mL glacial acetic acid (Amresco; Solon, Ohio, USA), 0.6 g methyl paraben (No 7685; Frontier Agricultural Sciences; Newark, Delaware, USA), and 6.7 mL ethanol.

Chemicals: A mixture of coconut free fatty acids (CFA) hydrolyzed from the natural coconut oil was purchased from Acme-Hardesty Co. (Blue Bell, Pennsylvania, USA). CFA consists of eight free fatty acids: caprylic acid (C8:0), capric acid (C10:0), lauric acid (C12:0), myristic acid (C14:0), palmitic acid (C16:0), stearic acid (C18:0), oleic acid (C18:1), and linoleic acid (C18:2) at a ratio of 6.9:7.3:52.7:17.1:8.4:1.3:6.0:0.3 (Zhu J J et al., 2018, supra). Synthetic fatty acid standards (all >98% purity) were purchased from Sigma-Aldrich (St. Louis, Missouri, USA). Test compounds were diluted to desired concentrations with ethanol (for C16:0 and C18:0) and hexane (for the rest of the fatty acid compounds tested). Ethanol was purchased from Pharmco (Brookfiled, CT, USA) and hexane was purchased form Sigma-Aldrich (St. Louis, Missouri, USA).

Statistical Analyses Differences in numbers of eggs or larvae plus pupae by different treatments were analyzed using a generalized linear mixed model in a randomized block design with replicate as a random factor and different oviposition deterrent treatments as a fixed factor using a Poisson distribution with log link function and maximum likelihood estimation. The means were compared using the Tukey-Kramer test (Proc Glimmix, SAS Institute 2009). Linear regression between the number of OFF eggs and dose of the 5c-ii blend was conducted using SAS (Proc REG, SAS Institute 2009).

### Example 2

### Effect of CFA and its Individual Components on Off Oviposition

The effect of CFA and its individual components on OFF oviposition was examined using laboratory two-choice cage experiments.

Evaluation of oviposition deterrence of CFA: OFF oviposition bioassays were conducted using laboratory two-choice cage experiments with guava juice-infused agar as an oviposition substrate. The agar plates were prepared by pouring 30 mL of boiled agar mixture [1000 mL distilled water, 500 mL guava juice (Deans Foods, El Paso, Texas, USA), 10 g agar, 0.6 g methylparaben, 6.7 mL 95% ethanol, and 3 mL acetic acid] into a 30 mL deli plastic cup to gel. The agar was then covered with a lid to avoid desiccation. The two-choice oviposition bioassay was conducted in screened cages using 20 mated OFF females per cage (12-18 day-old; Jang E B et al., 1997, “Attraction of female oriental fruit fly, Bactrocera dorsalis, to volatile semiochemicals from leaves and extracts of a non-host plant, Panax (Polyscias guilfoylei) in laboratory and olfactometer assays,” J. Chem. Ecol. 23:1389-1401) over 3 days.

Each cage was provided with a ball of water-saturated cotton, sugar, and protein hydrolysate in separate 30 mL deli cups and two guava juice agar plates-one treated with CFA diluted in hexane and the other treated with the hexane control. The agar plates were surface-treated either with 200 μL of hexane or 200 μL of CFA in one of 4 doses tested (20, 2, 0.2, and 0.02 mg/200 μL of hexane), placed into a fume hood for 10 minutes prior to use in bioassays, and positioned upside-down (i.e., treated side down) on the center of the outside top of the screened cage 17 cm apart from each other (i.e., one each of control and CFA treated), allowing female flies to oviposit on guava juice agar from the bottom through the cage screen. After three days, OFF eggs in the guava agar were gently separated from the agar in water and the number of eggs were individually counted (up to 100 eggs) or estimated volumetrically at 1 mL OFF eggs=20,000 eggs (Stephanie Gayle personal communication). The experiment was replicated six times per treatment.

Table 1 below presents the amount of individual coconut free fatty acid (CFA) components in 20 mg CFA and 20 mg equivalent dose of synthetic blends for “OFF negative compounds” blend (4c), “OFF negative+Off neutral compounds” blend (6c), and two subtraction blends of 6c (5c-i and 5c-ii) tested with B. dorsalis.

TABLE 1
Coconut Free Fatty Acid Components Tested for B. dorsalis

| | | Amount in | 20 mg CFA equivalent dose in | | | |
|---|---|---|---|---|---|---|
| | | 20 mg CFA | synthetic blends tested (mg) | | | |
| CFA Components | Activity | (mg) | 4c | 6c | 5c-i | 5c-ii |
| Caprylic acid (C8:0) | Negative | 1.38 | 1.38 | 1.38 | 1.38 | 1.38 |
| Capric acid (C10:0) | Negative | 1.46 | 1.46 | 1.46 | 1.46 | 1.46 |
| Lauric acid (C12:0) | Neutral | 10.54 | | 10.5 | | 10.5 |
| Myristic acid (C14:0) | Neutral | 3.42 | | 3.42 | 3.42 | |
| Palmitic acid (C16:0) | Positive | 1.68 | | | | |
| Stearic acid (C18:0) | Positive | 0.26 | | | | |
| Oleic acid (C18:1) | Negative | 1.20 | 1.20 | 1.20 | 1.20 | 1.20 |
| Linoleic acid (C18:2) | Negative | 0.06 | 0.06 | 0.06 | 0.06 | 0.06 |
| Total | | 20 | 4.10 | 18.02 | 7.52 | 14.6 |

When applied on the surface of guava juice infused agar, CFA significantly reduced OFF oviposition compared to hexane alone when treated at 20, 2, and 0.2 mg doses. As seen in FIG. 1A, there was an 87% oviposition reduction when treated with 20 mg CFA, as seen in FIG. 1B, there was an 80% oviposition reduction when treated with 2 mg CFA, as seen in FIG. 1C, there was a 45% oviposition reduction when treated with 0.2 mg CFA (20 mg: F_{1,5}=4172.07, P<0.0001; 2 mg: F_{1,5}=3077.91, P<0.0001; 0.2 mg: F_{1,5}=1006.71, P<0.0001). As seen in FIG. 1D, at the 0.02 mg dose, oviposition deterrent activity of CFA was not observed (F_{1,5}=1.94, P=0.2224).

Determination of bioactive oviposition deterrent components from CFA: A series of bioassays was conducted to identify key deterrent components of CFA for OFF using the same two-choice bioassay design described above. To determine the minimum dose necessary to maintain the deterrent activity of a compound, oviposition deterrence of individual components of CFA was initially evaluated at 20 mg/agar plate and subsequently tested at lower doses (2, 1, and 0.2 mg) if significant oviposition deterrence was observed at the immediately higher dose. Ethanol was used as control and for preparing dilutions of C16:0 and C18:0. Hexane was used as control and for dilutions of the other six compounds tested. Based on the outcome of these bioassays, the eight free fatty acid components were assigned to “OFF negative” (i.e., oviposition reduced), “OFF neutral” (i.e., no effect on oviposition), and “OFF positive” (i.e., oviposition increased) compound groups. Using these groupings, four different blends were formulated (indicated in Table 1), composed at the equivalent ratios and concentrations of each component found in CFA (Zhu J J et al., 2018, supra), to determine key bioactive CFA components in terms of oviposition deterrence on OFF. The approach involved testing the bioactivity of the OFF negative-component blend (4c blend) for oviposition deterrence at three different doses (2, 0.2, and 0.02 mg CFA equivalent/agar), first comparing with hexane control, then with CFA at respective equivalent doses. As the 4c blend was not as effective as CFA, a “OFF negative+OFF neutral” component blend (6c blend) was then formulated, and its effect compared with CFA at 2 and 0.2 mg CFA equivalent/agar. Two subtraction blends with one of the two OFF neutral components removed from the 6c blend (5c-i and 5c-ii blends) were formulated and compared with the 6c blend at 2 and 0.2 mg CFA equivalent/agar. The experiment was replicated four to six times per treatment.

When tested as individual components at the 20 mg dose: four compounds significantly reduced OFF oviposition on guava juice infused agar when compared to control agar. As shown in FIG. 2G, C8:0 reduced oviposition by 95% (F_{1,5}=3628.5, P<0.0001), as seen in FIG. 2J, C10:0 reduced oviposition by 92% (F_{1,5}=3823.6, P<0.0001), as seen in FIG. 2A, C18:1 reduced oviposition by 100% (F_{1,5}=206.6, P<0.0001), and as seen in FIG. 2D, C18:2 reduced oviposition by 99% (F_{1,5}=1088.2, P<0.0001). These compounds are referred to as “OFF negative” compounds. Two compounds did not affect OFF oviposition on guava juice infused agar when compared to control agar. As seen on FIG. 2L and FIG. 2M, C12:0 (F_{1,5}=1.09, P=0.345) and C14:0 (F_{1,5}=0.13, P=0.7337) did not affect OFF oviposition, and are referred to as “OFF neutral” compounds. Two compounds increased oviposition on guava juice infused agar when compared to control agar. As seen on FIG. 2N C16:0 increased oviposition by 60% (F_{1,5}=2022.72, P<0.0001), and as seen on FIG. 2O C18:0 increased oviposition by 29% (F_{1,5}=334.42, P<0.0001). These compounds are referred to as “OFF positive” compounds. When the four OFF negative compounds were individually tested at lower doses, three compounds (C8:0, C18:1 and C18:2) maintained OFF oviposition deterrence down to the 2 mg dose. These compounds were C8:0, results shown on FIG. 2H (F_{1,4}=70.93, P=0.0011); C18:1, results shown on FIG. 2B (F_{1,4}=1258.9, P<0.0001); and C18:2, results shown on FIG. 2E (F_{1,4}=1027.52, P<0.0001).

The information in this Example shows that the eight free fatty acid components of CFA may be assigned into three different groups: “OFF negative” (i.e., OFF oviposition reduced), “OFF neutral” (i.e., no effect on OFF oviposition), or “OFF positive” (i.e., OFF oviposition increased). Using these groupings, four different blends were formulated (4c, 6c, 5c-i, and 5c-ii), composed at the equivalent ratios and concentrations of each component found in CFA

### Example 3

### Evaluation of Key-Component Blend Oviposition Deterrence

The OFF oviposition deterrence of the 5c-ii key component blend was tested at different concentrations in a no-choice assay. [0089] no-choice assay The oviposition deterrence of the key-component blend (5c-ii blend) was evaluated using a no-choice bioassay design. One agar plate, surface-treated either with 200 μL of hexane as control or 200 μL of the 5c-ii blend at one of three doses (20, 2 or 0.2 mg CFA equivalent/200 μL of hexane/agar plate), was placed upside-down (i.e., treated place down) on the center of the top of the screened cage after hexane evaporated in fume hood for 10 minutes. Each cage was provided with 20 mated female OFF, water, sugar, and protein hydrolysate as described above for the two-choice experiments. After 3 days, OFF eggs were gently separated from the agar in water and the number of eggs counted individually or estimated volumetrically as described above. The experiment was replicated eight times per treatment.

As seen in FIG. 3A and FIG. 3B, when the four OFF-negative fatty acid compounds (C8:0, C10:0, C18:1 and C18:2) were tested as a blend (4c blend), formulated at the equivalent concentrations of the four compounds in 2, 0.2 and 0.02 mg doses of CFA, the 4c blend significantly reduced OFF oviposition at 2 and 0.2 mg CFA equivalent doses (0.41 and 0.041 mg total of the four compounds, respectively; Table 1) compared to hexane control (2 mg CFA equivalent: F_{1,3}=62.77, P=0.0042; 0.2 mg CFA equivalent: F_{1,3}=1178.3, P<0.0001). However, as seen in FIG. 3C, the oviposition deterrence of the 4c blend was not observed at 0.02 mg CFA equivalent dose (0.00396 mg) (F_{1,3}=743.9, P<0.000).

on host fruit The oviposition deterrence of the key-component blend (5c-ii; Table 1) applied to two known OFF host fruits [papaya (Carica papaya L.) and tomato (Lycopersicon esculentum Mill.)] was evaluated using a two-choice bioassay as described above with only exception that fruits were held inside the cage. Ripe papaya and grape tomato were purchased from a local grocery. Each cage was provided with two fruit-one surface-treated with the 5c-ii blend at the equivalent dose of 2 mg CFA/agar plate and the other treated with hexane only as the control. Each grape tomato was treated with 200 μL hexane or the 5c-ii blend. Each papaya was surface-treated with 3 mL hexane, or the 5c-ii blend to compensate for the larger surface area. Twenty female OFF were allowed to oviposit on fruit for 3 days, after which the fruits were removed and stored in individual cages at 23° C. For tomato, the numbers of OFF eggs oviposited in fruit were counted 24 hours after the conclusion of the oviposition assay by carefully dissecting the fruit. For papaya, the fruit was dissected 2 weeks after the conclusion of the oviposition assay and the number of larvae and pupae found in the cages were counted. The experiment was replicated four times per treatment.

As seen in FIG. 4A and FIG. 4B, when the 4c blend was compared to CFA in two-choice assays, the numbers of OFF eggs were significantly greater in the 4c blend-treated agar than CFA-treated agar at both 2 and 0.2 mg CFA equivalent doses (2 mg CFA equivalent: F_{1,3}=1215.63, P<0.0001; 0.2 mg CFA equivalent: F_{1,3}=36.69, P=0.0090), indicating potential absence of some key deterrent components in the 4c blend. As seen in FIG. 4C and FIG. 4D, when the two “neutral” compounds (C12:0, C14:0), in terms of the behavioral effect as individual compounds, were added to the 4c blend, there were no significant differences in numbers of OFF eggs between agar plates treated with the “negative+neutral” component blend (6c blend) and CFA at 2 and 0.2 mg CFA equivalent doses (1.802 and 0.1802 mg of six compounds, respectively) (2 mg CFA equivalent: F_{1,3}=5.45, P=0.1017; 0.2 mg CFA equivalent: F_{1,3}=2.32, P=0.2249). Subsequent subtraction tests showed that, between the two “neutral” compounds (C12:0 and C14:0), C_{12:0} was the key oviposition deterrent component. As seen on FIG. 5A, when tested at 2 mg CFA equivalent, removing C12:0 from the 6c blend (5c-i blend) resulted in a significant increase in the number of OFF eggs oviposited on 5c-i blend-treated agar compared to the number of eggs on the 6c blend treated agar (F_{1,3}=12.11, P=0.0400). However, as seen in FIG. 5B, removing C14:0 from the 6c blend (5c-ii blend) did not affect the level of OFF oviposition on agars treated with the 5c-ii bend compared with the 6c blend (F_{1,3}=0.2, P=0.6850).

As seen in FIG. 6, under the no-choice setting, the 5c-ii key component blend (Table 1) showed significant oviposition deterrent activity against OFF. The 5c-ii blend treatment reduced OFF oviposition by 40, 30, and 16% when treated at 20, 2 and 0.2 mg CFA equivalent doses (14.6, 1.46 and 0.146 mg total of the five compounds, respectively; Table 1) compared to hexane control (F_{3,21}=955.46, P<0.0001). The oviposition deterrence was dose-dependent: there was a significant linear relationship between number of eggs and the 5c-ii blend doses tested (Y=1355+415*X where Y=number of OFF eggs on agar plate and X=dose of 5c-ii blend; r²=0.99, P=0.0050).

As seen on FIG. 7A to FIG. 7C, the 5c-ii key component blend was effective at reducing OFF oviposition on OFF host fruits. Papaya and grape tomato treated with the 5c-ii blend at 2 mg CFA equivalent dose suffered 95 and 72% lower incidence of OFF oviposition than fruits treated with the hexane control (papaya: F_{1,3}=219.05, P=0.0007; tomato: F_{1,3}=3481.27, P<0.0001).

In addition, as seen in FIG. 8A to FIG. 8E, among the five odd-numbered free fatty acids tested individually from C9-C17, three compounds (pelargonic acid, undecylic acid and tridecylic acid) significantly reduced B. dorsalis oviposition when directly applied on artificial oviposition substrate (guava juice agar) as an individual compound at 20 mg dose.

The results obtained in this Example show that treatment with the 5c-ii blend reduced OFF oviposition in a concentration-dependent manner.

### Example 4

### Effect of CFA and its Individual Components on SWD Oviposition

The effect of CFA and its individual components on SWD oviposition was tested in field and laboratory tests.

Field test 1 A field test was performed to determine whether CFA had SWD oviposition deterrent activity under field conditions. The effect of CFA on SWD infestation was evaluated by applying CFA to primocane raspberries planted in 15 small plots established in Geneva, New York following the methods described in Cha D H et al. (2021, “2-Pentylfuran: a novel repellent of Drosophila suzukii,” Pest Manag. Sci. 77:1757-1764). Each plot (=replication) had 3 rows (7m) of 11 raspberry plants with 2.4 m spacing between the rows and each plot was separated by at least 0.5 km from other plots. The plantings were established in 2018 and the trial was conducted in the fall of 2019 as ripe raspberries were present along with high levels of SWD infestations in the area. Within each plot, two fruiting canes (one for CFA treatment and one for control) with fully grown, green berries were selected with each cane separated by at least 3 m. On 12 Sep. 2019, all pink or ripe berries were removed and the fruiting end of the canes bearing the green berries was covered with fine mesh bags (Trimaco, Inc.; Morrisville, North Carolina, USA) and the bags sealed around the cane with a twist tie. This allowed the selected green to pinkish fruit to ripen but prevented oviposition by resident SWD. The bags were removed from all canes four days later. Per each plot, raspberries in one of the two pre-bagged raspberry clusters were individually treated with 20 mg CFA/200 μL hexane/berry. The raspberries in the other pre-bagged raspberry cluster were individually treated with 200 μL hexane/berry as the control. After two days, the ripe experimental fruits were collected, returned to the laboratory, placed in rearing cups (540 mL deli cups filled with agar prepared with water only to an approximate depth of 1 cm, with a screen lid) for 6 days in a walk-in growth chamber (25° C., 55% RH, 16:8 L:D). The number of emerged larvae and pupae were counted.

As seen in FIG. 9, when applied on ripe raspberries in the field at 20 mg CFA/berry, CFA significantly reduced SWD oviposition on treated raspberries. There were 64% fewer SWD larvae and pupae reared out from CFA treated berries compared to control raspberries over 2 days (F_{1,14}=8.93, P=0.0098).

Laboratory choice test 1 Oviposition bioassays were conducted at USDA-ARS in Hilo, Hawaii using a laboratory two-choice cage experimental set-up with organic raspberries purchased from a local grocery as an oviposition substrate. For all laboratory assays listed below, the receptacles of the raspberries were stuffed with cotton to prevent flies from ovipositing on the interior of the fruit as described previously in Cha D H et al. (2021, supra). The two-choice oviposition bioassay was conducted over 24 hours in screened cages (30 cm W×30 cm L×30 cm H; BugDorm-2120 Insect tent; shop.bugdorm.com) with 30 female and 10 male SWD (7-8 days old) released per cage. Each cage was provided with cotton moistened with water in a 20 mL deli cup and two 30 mL deli cups; one with two raspberries treated with CFA diluted in hexane and the other with two raspberries treated with hexane only. Each raspberry was surface-treated either with 200 μL of hexane or 200 μL of CFA in one of three doses (20, 2, or 0.2 mg CFA/200 μL hexane), placed into a fume hood for 10 minutes or until used in the bioassay. The deli cups with the treated berries were positioned in the center of the floor of the screened cage, 17 cm apart from each other. Female flies were allowed to oviposit on the surface of raspberries for 24 hours. At the conclusion of the bioassay, each 30 mL deli cup containing two raspberries was moved into a 600 mL deli cup with a mesh cap, held for 8 days (22.1±1.9° C., 71.7±3.1% RH, 16:8 L:D), when the number of larvae and pupae were counted. The experiment was replicated four times per treatment.

Laboratory choice test 1 As seen in FIG. 10A to FIG. 10C, when applied on the surface of organic raspberries at a 20 mg dose, CFA significantly reduced SWD oviposition by 99% relative to control (F_{1,3}=167.34, P=0.0010). The deterrent effect appeared to be dose dependent. The CFA treatment significantly reduced SWD oviposition at the 2 mg dose, but at a reduced rate of 19% (F_{1,3}=12.52, P=0.0384). At the 0.2 mg dose, oviposition deterrent activity of CFA was not observed with significantly more eggs oviposited in 0.2 mg CFA treated agar (F_{1,3}=27.27, P=0.0137).

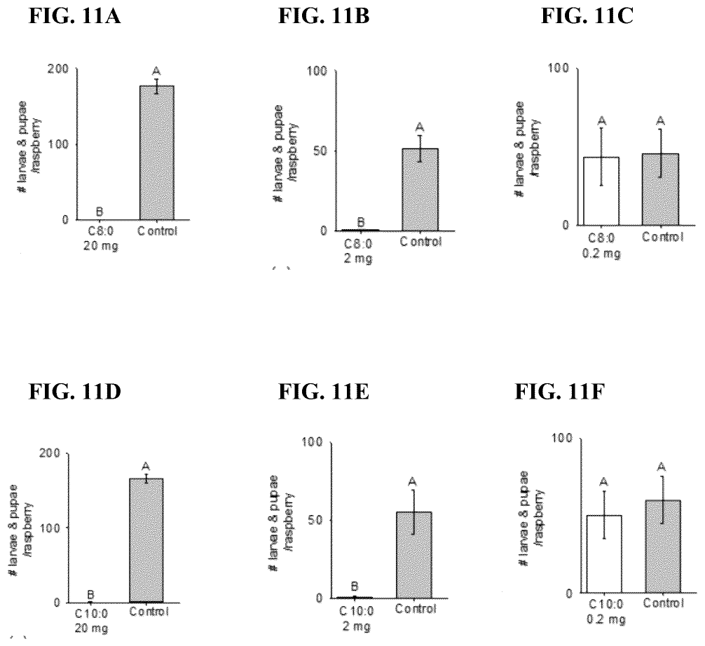

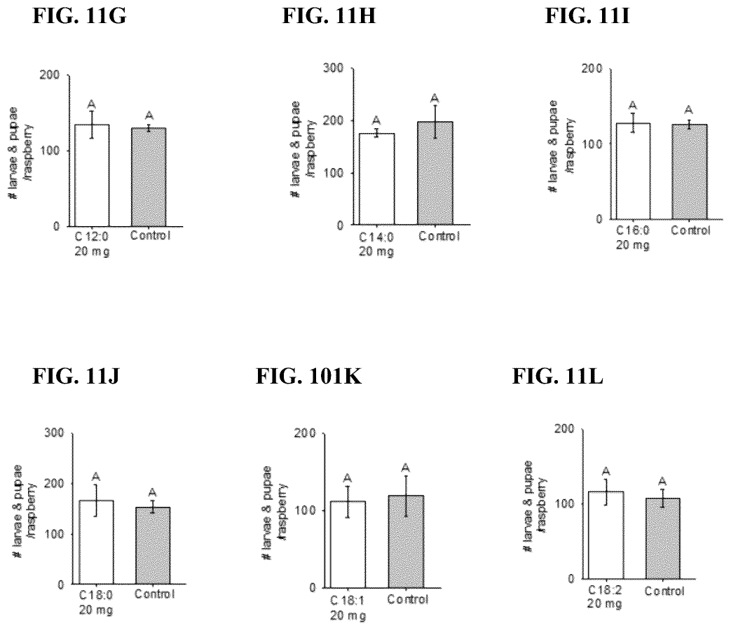

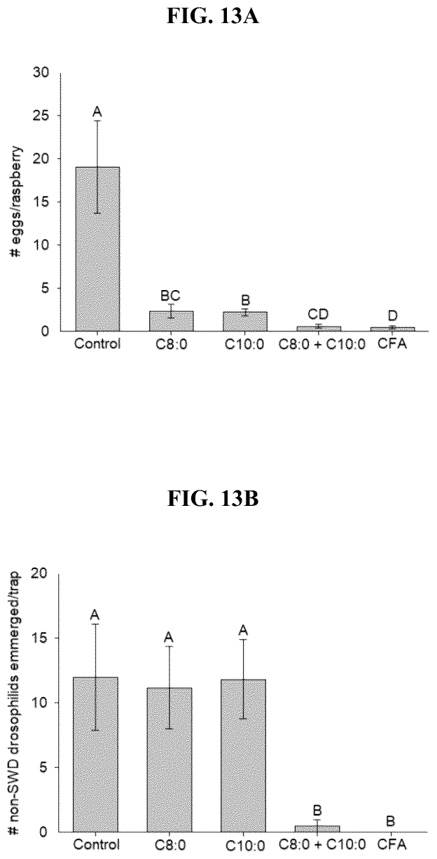

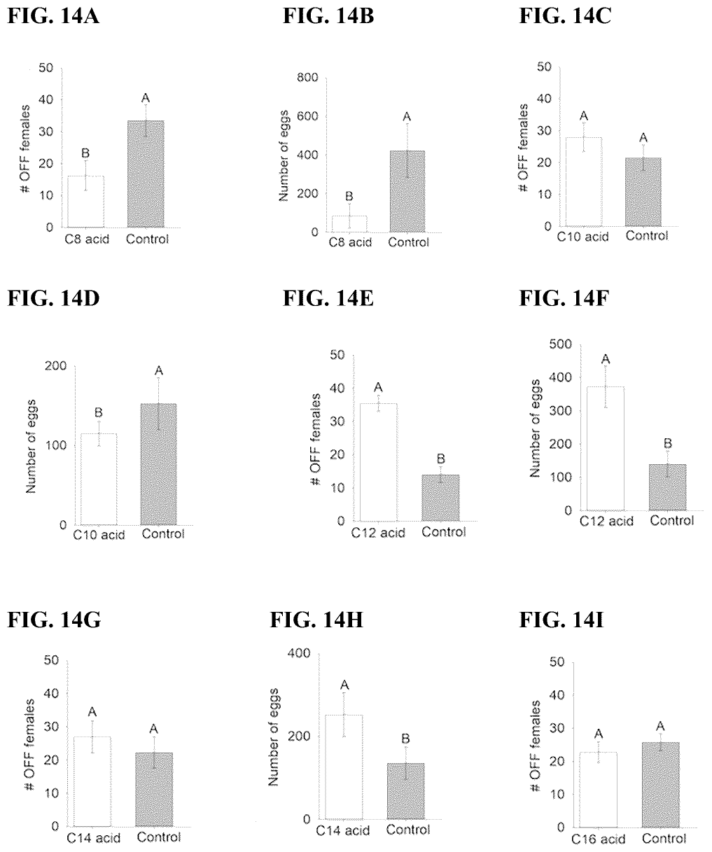

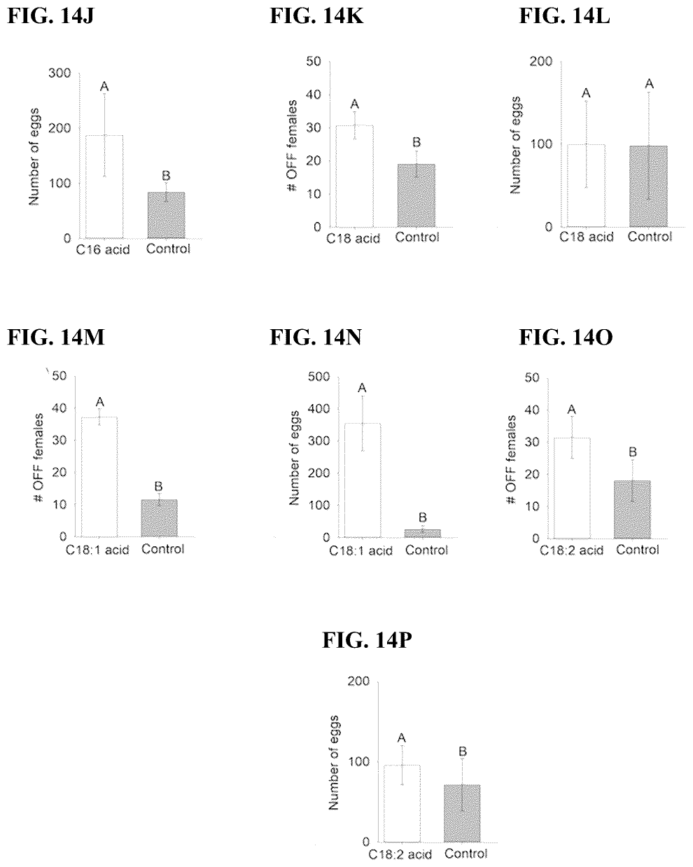

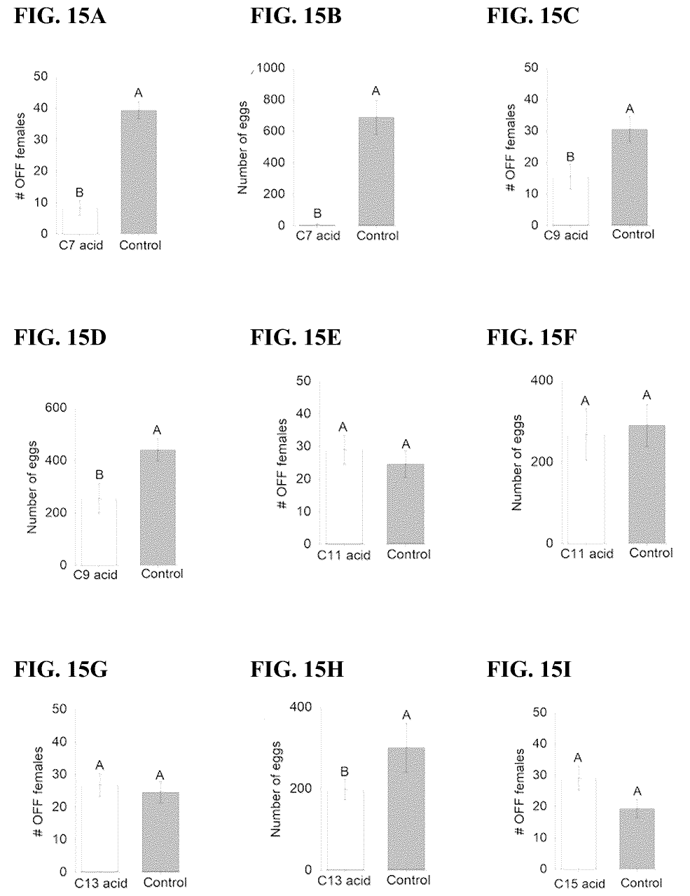

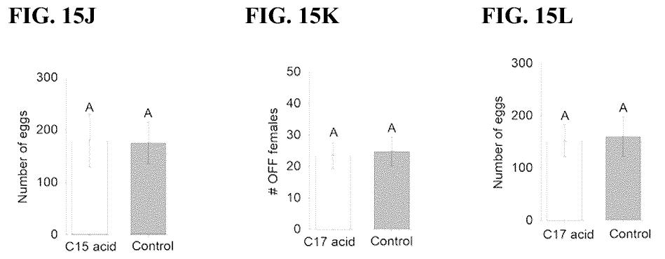

As seen in FIG. 11A to FIG. 11L, among the eight CFA compounds, there were two compounds (caprylic acid and capric acid) key to the oviposition deterrence of CFA to D. suzukii when applied on raspberry fruit in the laboratory. FIG. 12A to FIG. 12D show the efficiency of a mixture of the two component “negative-compounds” blend (2c) in deterring D. suzukii oviposition. As seen in FIG. 13A, the same compounds were effective in oviposition deterrence in the field. FIG. 13B shows that CFA and the two bioactive compounds for D. suzukii were also effective at reducing oviposition by other non-target Drosophila flies. Given that CFA and its bioactive compounds are effective at reducing oviposition from multiple species of fruit infesting flies, they have potential use as sprayable behavioral control strategies against wide variety of fruit infesting flies.

Laboratory choice test 2 A series of bioassays were conducted in Hilo, Hawaii to identify key bioactive deterrent components of CFA for SWD using the same two-choice bioassay described above. To determine the minimum dose necessary to maintain deterrent activity of a compound, individual components of CFA were initially evaluated at 20 mg/raspberry and subsequently tested at lower doses (2 and 0.2 mg) if significant oviposition deterrence was observed at an immediately higher dose. Due to solubility differences, ethanol was used as control and for dilution of C16:0 and C18:0, while hexane was used as control and for dilution of the other six compounds tested. Based on the outcome of these bioassays, the eight free fatty acid components of CFA were grouped into two groups; “SWD negative” compounds (i.e., SWD oviposition was reduced) and “SWD neutral” compounds (i.e., no effect on oviposition), and tested whether the blend of “SWD negative” compounds had the same oviposition deterrence as the CFA at their equivalent concentrations as in CFA (see Table 2). The oviposition deterrence of the blend of “SWD negative” compounds was first compared to hexane at three different doses (20, 2 and 0.2 mg CFA equivalent/raspberry) and subsequently compared to CFA at 2 mg equivalent dose.

Table 2 below lists the amount of individual coconut free fatty acid (CFA) components in 20 mg CFA and in 20, 2 and 0.2 mg CFA-equivalent doses of 2-component “SWD negative compounds” synthetic blend (2c blend) tested with D. suzukii.

TABLE 2
Coconut Free Fatty Acid Components Tested for D. suzukii

| | | | Amount in 2c blend at different CFA | | |
|---|---|---|---|---|---|
| | Behavioral | Amount in 20 | equivalent (eq.) doses (mg) | | |
| CFA components | activity | mg CFA (mg) | 20 mg eq. | 2 mg eq. | 0.2 mg eq. |
| Caprylic acid (C8:0) | Negative | 1.38 | 1.38 | 1.38 | 1.38 |
| Capric acid (C10:0) | Negative | 1.46 | 1.46 | 1.46 | 1.46 |
| Lauric acid (C12:0) | Neutral | 10.54 | | | |
| Myristic acid (C14:0) | Neutral | 3.42 | | | |
| Palmitic acid (C16:0) | Neutral | 1.68 | | | |
| Stearic acid (C18:0) | Neutral | 0.26 | | | |
| Oleic acid (C18:1) | Neutral | 1.20 | | | |
| Linoleic acid (C18:2) | Neutral | 0.06 | | | |
| Total | | 20 | 2.84 | 0.284 | 0.0284 |

When tested as individual compounds at 20 mg doses, the two “SWD negative” compounds (C8:0 and C10:0) almost completely inhibited oviposition in treated raspberries. As seen in FIG. 11A, zero eggs were oviposited among all of the C8:0-treated raspberries, and as seen in FIG. 11D one egg was oviposited among all of the C10:0-treated raspberries, while an average of 170.9 eggs were oviposited per control raspberry (C8:0, F_{1,3}=42.95, P=0072; C10:0, F_{1,3}=42.12, P=0.0074). Six “SWD neutral” compounds (C12:0, C14:0, C16:0, C18:0, C18:1 and C18:2) did not increase or decrease SWD oviposition, as seen in FIG. 11G for C12:0, (F_{1,3}=0.21, P=0.6757); FIG. 11H for C14:0 (F_{1,3}=5.18, P=0.1074); FIG. 11I for C16:0 (F_{1,3}=0.06, P=0.8179); FIG. 11J for C18:0 (F_{1,3}=1.96, P=0.2559); FIG. 11K for C18:1 (F_{1,3}=1.04, P=0.3823); and FIG. 11L for C18:2 (F_{1,3}=1.15, P=0.3621). When the two SWD negative compounds were further tested individually at lower doses (2 and 0.2 mg), a similar response was observed as was observed for the CFA treatment. Both compounds maintained oviposition deterrence at the 2 mg dose but with reduced efficacy compared to the 20 mg dose (data for C8:0 is shown in FIG. 11B (F_{1,3}=28.2, P=0.0130); and data for C10:0 is shown in FIG. 11E (F_{1,3}=63.38, P=0.0041). Reduced SWD oviposition was not detected when the two compounds were used at the 0.2 mg dose (data for C8:0 is shown in FIG. 11C (F_{1,3}=0.28, P=0.63290); and data for C10:0: is shown in FIG. 11F (F_{1,3}=3.44, P=0.1607).

When the two SWD negative fatty acid compounds were tested as a blend (2c blend, Table 2), formulated at the equivalent concentrations of the two compounds as in 20, 2 and 0.2 mg doses of CFA, the 2c blend significantly reduced SWD oviposition in raspberries at 20 and 2 mg CFA equivalent doses compared to hexane control. Data for 20 mg CFA equivalent is shown in FIG. 12A (F_{1,3}=41.85, P=0.0075); and data for 2 mg CFA equivalent is shown in FIG. 12B (F_{1,3}=10.18, P=0.0497). However, as seen in FIG. 12C, the effect was not observed at 0.2 mg CFA equivalent dose (F_{1,3}=2.63, P=0.2030). As seen in FIG. 12D, a subsequent test showed that the 2c blend treated at 2 mg CFA equivalent dose was as effective as 2 mg CFA (F_{1,3}=3.43, P=0.1613).

The results obtained in this Example show that the two “SWD negative” compounds (C8:0 and C10:0) almost completely inhibited oviposition in treated raspberries, and that the 2c blend significantly reduced SWD oviposition in raspberries.

### Example 5

### Evaluation of Key-Component Blend Oviposition Deterrence

The oviposition deterrence of the 2c key-component blend and its two individual components against SWD and non-SWD drosophilids was tested under laboratory and field conditions.

Laboratory no-choice test The oviposition deterrence of the key-component blend determined from the “Laboratory choice test 2” described above (2c blend composed of C8:0 and C10:0; Table 2) was tested using a no-choice bioassay in Geneva, New York, USA using organic raspberries purchased from a local grocery and using 30 cm×30 cm×30 cm screened cages as described above. Each cage held four raspberries on a 10 cm diameter glass petri dish lined with filter paper and assigned to one of five treatments: 1) 20 mg of CFA/200 μL hexane/raspberry, 2) C_{8:0} at 20 mg CFA equivalent dose/200 μL hexane/raspberry, 3) C_{10:0} at 20 mg CFA equivalent dose/200 μL hexane/raspberry, 4) 2c blend at 20 mg CFA equivalent dose/200 μL hexane/raspberry, or 5) 200 μL of hexane control/raspberry (see Table 2 for equivalent doses). Twenty SWD females (5 days old) were released into each cage and allowed to oviposit on raspberries over 24 hours in an environmental chamber (25° C., 55% RH, 16:8 L:D). At the end of each trial, the raspberries were inspected under a dissecting microscope and the eggs were counted. The experiment was replicated eight times per treatment.

As seen in FIG. 12A, CFA, the 2c blend, and the individual components significantly reduced SWD oviposition in raspberries compared to the solvent control, when treated at 20 mg CFA or 20 mg CFA equivalent doses (F_{4,28}=53.69, P<0.0001). There was no significant difference between the number of SWD eggs oviposited in raspberries treated with CFA or the 2c blend. Significantly fewer eggs were oviposited in raspberries treated with CFA than with C8:0 or C10:0, while significantly fewer eggs were oviposited in raspberries treated with 2c blend than with C10:0 but not with C8:0.

Field test 2 The oviposition deterrence of the 2c key-component blend and its two individual components against SWD and non-SWD drosophilids was tested under field conditions. This experiment was conducted in a guava orchard (19° 36′33.6″N, 155° 04′ 12.6″W) located near Hilo, Hawaii. To monitor oviposition, four sentinel organic raspberries purchased from a local grocery were placed (receptacles stuffed with cotton) inside a deli cup (600 mL; Placon, Madison, Wisconsin, USA). Each cup had nine 1 cm diameter holes spaced 3 cm apart along the cup's circumference and 8.5 cm from the bottom, which allowed the drosophilids to enter the cup. The four raspberries in each cup were surface-treated with one of five treatments: 1) 2c blend at 20 mg CFA equivalent/200 μL hexane/raspberry, 2) C8:0 at 20 mg CFA equivalent/200 μL hexane/raspberry, 3) C10:0 at 20 mg CFA equivalent/200 μL hexane/raspberry, 4) CFA at 20 mg/200 μL hexane/raspberry, or 5) 200 μL of hexane control/raspberry. The deli-cup traps were hung in guava trees 1.5 m from the ground with at least 10 m spacing between adjacent traps. After 2 days, all traps were collected from the orchard. Raspberries were removed from the traps, placed in rearing cups (600 mL deli cup with organdy cap), held in environmental chamber (22.1±1.9° C., 71.7±3.1% RH, 16:8 L:D), and monitored over a 2-week period. All emerged adults were counted and identified as SWD or non-SWD drosophilids. The treatments were replicated 12 times.

As seen in FIG. 12B, when CFA, 2c blend, C8:0 and C10:0 were tested at 20 mg CFA or its equivalent doses in the guava orchard, raspberries treated with either the 2c blend or CFA had significantly reduced oviposition from resident drosophilids compared to the raspberries treated with C8:0, C10:0, or the solvent control (F_{4,44}=20.76, P<0.0001). Majority of emerged drosophilids were non-SWD, including D. immigrans, D. simulans, and D. melanogaster. Only seven SWD adults emerged from raspberries with 4 SWD emerging from raspberries treated with hexane control, 2 SWD emerging from raspberries treated with C10:0, and 1 SWD emerging from raspberries treated with the 2c blend. There was no significant difference between numbers of emerged non-target drosophilids adults between the 2c blend and CFA-treated raspberries.

The results obtained in this Example show that raspberries treated with either the 2c blend or CFA had significantly reduced oviposition from resident drosophilids compared to the raspberries treated with C8:0, C10:0, or the solvent control.

### Example 6

### Fatty Acid Methyl Ester B. dorsalis Spatial Deterrence

Fatty acid methyl esters were tested for spatial oviposition deterrence of B. dorsalis.

In addition to CFA, a series of odd-numbered carbon fatty acids (C9:0 to C17:0) and fatty acid methyl esters were evaluated for the spatial deterrence to B. dorsalis that results in oviposition reduction. Table 3 below lists the fatty acid methyl esters tested for spatial repellency for Bactrocera dorsalis.

TABLE 3
Fatty Acid Methyl Esters Tested for B. dorsalis Spatial Repellency

| Compounds | Abbreviation |
|---|---|
| Methyl caprylate | C8:0 ME |
| Methyl pelargonate | C9:0 ME |
| Methyl caprate | C10:0 ME |
| Methyl undecanoate | C11:0 ME |
| Methyl laurate | C12:0 ME |
| Methyl tridecanoate | C13:0 ME |
| Methyl myristate | C14:0 ME |
| Methyl pentadecanoate | C15:0 ME |
| Methyl palmitate | C16:0 ME |
| Methyl heptadecanoate | C17:0 ME |

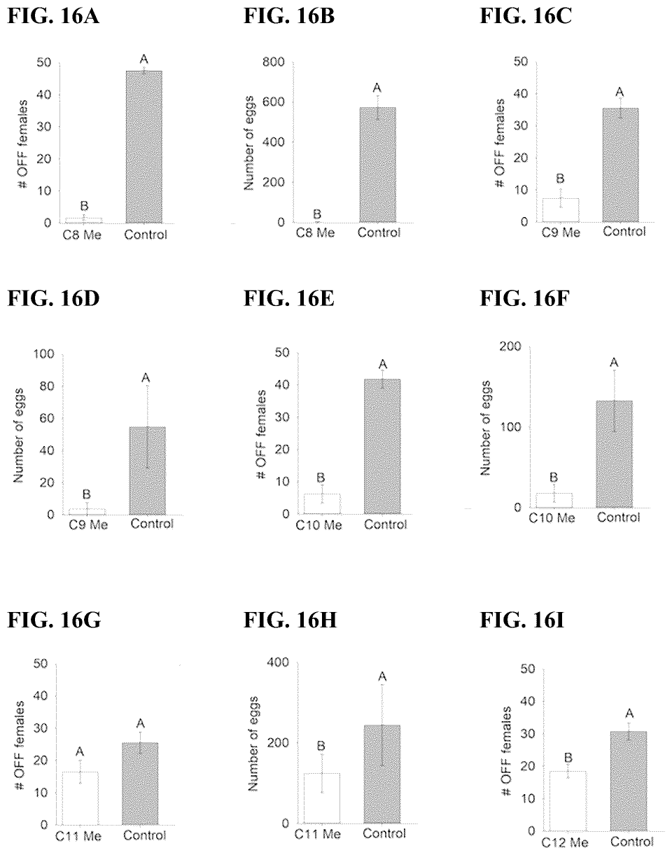

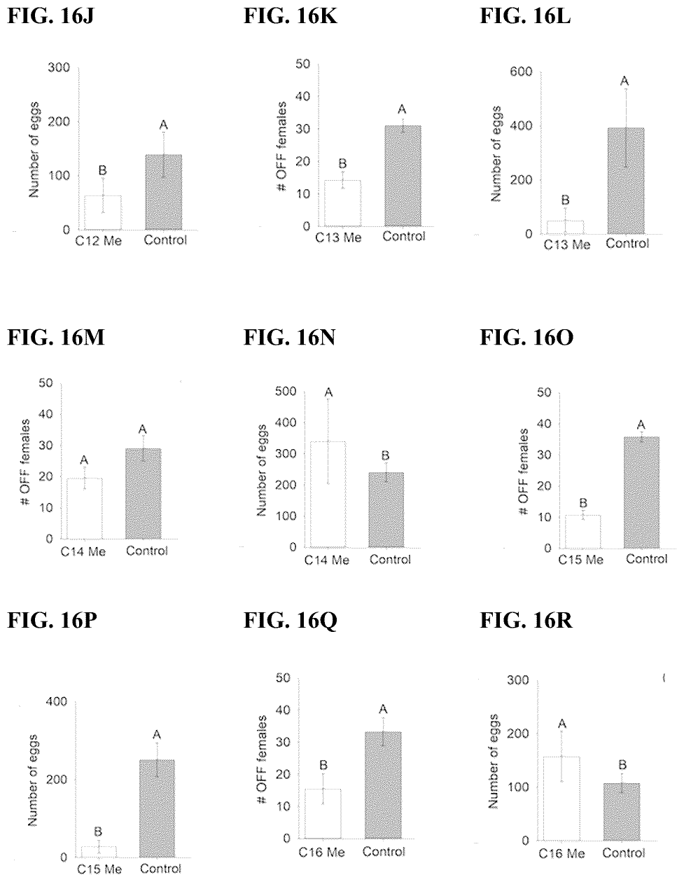

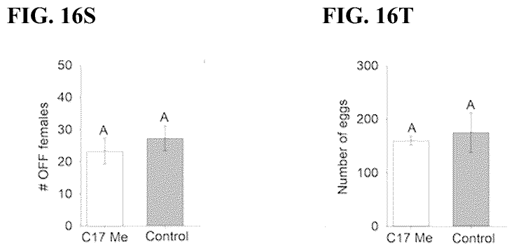

When tested individually, heptanoic acid (C7:0), caprylic acid (C8:0), and pelargonic acid (C9:0) significantly reduced female B. dorsalis attraction and oviposition to host fruit odors. Among the ten fatty acid methyl ester compounds tested (listed in Table 3), seven compounds (C8:0 ME, C9:0 ME, C10:0 ME, C11:0 ME, C12:0 ME, C13:0 ME, and C15:0 ME) significantly reduced female B. dorsalis attraction and oviposition in response to host fruit odors. FIG. 16A, FIG. 16C, FIG. 16E, FIG. 16G, FIG. 16I, FIG. 16K, FIG. 16M, FIG. 16O, FIG. 16Q, and FIG. 16S show the mean numbers (±SEM) of mated female B. dorsalis flies captured, and FIG. 16B, FIG. 16D, FIG. 16F, FIG. 16H, FIG. 16J, FIG. 16L, FIG. 16N, FIG. 16P, FIG. 16R, and FIG. 16T show the number of B. dorsalis eggs oviposited in traps baited with guava juice (control) and with guava juice plus one of the coconut fatty acid methyl ester compounds in two-choice bioassays. For each test, different letter on the bar indicate a significant difference by Tukey-Kramer tests at P<0.05, n=4.

The results obtained in this Example show that heptanoic acid (C7:0), caprylic acid (C8:0), pelargonic acid (C9:0), methyl caprylate (C8:0 ME), methyl pelargonate (C9:0 ME), methyl caprate (C10:0 ME), methyl undecanoate (C11:0 ME), methyl laurate (C12:0 ME), methyl tridecanoate (C13:0 ME), and methyl pentadecanoate (C15:0 ME) significantly reduced female B. dorsalis attraction and oviposition in response to host fruit odors.

### Example 7

### Deterrence and Behavioral Mode of CFFA on Zeugodacus cucurbitae Oviposition

Previous studies have reported oviposition-deterring properties of coconut free fatty acid (CFFA) compounds on fruit flies with different key oviposition-deterrent components identified for different species. In this Example, the oviposition deterrence of eight CFFA compounds was evaluated using laboratory two-choice bioassays against melon fly, Zeugodacus cucurbitae, key-bioactive deterrent compounds were determined, and the Z. cucurbitae behavioral mode evaluated.

Zeugodacus cucurbitae used here were sourced from colonies at the U.S Pacific Basin Agricultural Research Center in Hilo, Hawaii, and maintained on a standard larval diet containing wheat, sugar, and yeast (Tanaka at al., Supra). For oviposition behavior assays, newly eclosed male and female flies were held for 12 to 18 days in screened cages (30 cm×30 cm×30 cm (W×L×H); BugDorm-2120@ Insect rearing tent; shop.bugdorm.com) and provisioned with sugar and protein hydrolysate as food at 24° C., 55 to 60% relative humidity, and 12L:12D photoperiod.

Oviposition bioassays were conducted with mated female flies, using pumpkin juice-infused agar as an oviposition substrate. A small petri dish (60×15 mm) filled with 10 mL of 1% agar mixed in pumpkin juice was used as an oviposition substrate. The agar plates were surface-treated either with 200 μL of ethanol or 200 μL of CFFA in one of 4 doses tested (20, 2, 0.2, and 0.02 mg/200 μL of ethanol), placed into a fume hood for 10 minutes for solvent evaporation prior to use in bioassays, and positioned upside-down (i.e. treated side down) on top of the 30×30×30 cm (W×L×H) screened cage 17 cm apart from each other (i.e. one each of control and CFFA treated), allowing 20 female flies (14 to 18 day-old) to oviposit on pumpkin juice agar from the bottom through the cage screen for 24 hours. Each cage was provided with a ball of water-saturated cotton, sugar, and protein hydrolysate in separate 30 mL deli cups and two oviposition substrates-one treated with CFFA diluted in ethanol and the other treated with the ethanol control. After 24 hours, Z. cucurbitae eggs in the pumpkin agar were gently separated from the agar in water and the number of eggs were individually counted. The experiment was replicated five times per treatment.

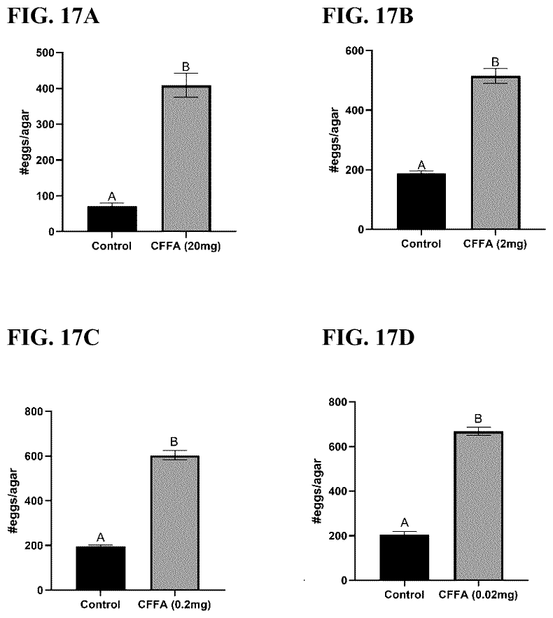

Surface-treating pumpkin juice-infused agar plates with significantly increased Z. cucurbitae oviposition. As seen in FIG. 17A, Z. cucurbitae oviposition increased by 85.2% in the presence of 20 mg dose of CFFA when compared to ethanol-only treated agar (t=30.66, P<0.0001). Z. cucurbitae oviposition also increased with CFFA at doses of 2 mg (t=38.39, P<0.0001, FIG. 17B), 0.2 mg (t=57.21, P<0.0001, FIG. 17C), and 0.02 mg (t=63.52, P<0.0001, FIG. 17D).

CFFA was not an effective oviposition deterrent for Z. cucurbitae which is contrary to our previous work on B. dorsalis (Roh et al., 2023a). Hence further studies were conducted to identify the effect of individual CFFA components on Z. cucurbitae oviposition using the same two-choice bioassay design described above. Oviposition deterrence of individual components of CFFA was initially evaluated at 20 mg/agar plate and subsequently tested at lower doses (2, 1, and 0.2 mg) if significant oviposition deterrence was observed at the immediately higher dose. CFFA components were categorized into three groups “negative” (i.e., oviposition reduced), “neutral” (i.e., no effect on oviposition), and “positive” (i.e., oviposition increased) based on bioassay outcome. Using these categories, further formulations were made to determine key bioactive CFFA components in terms of oviposition deterrence on Z. cucurbitae at the equivalent ratios and concentrations of each component found in CFFA (Zhu et al. 2018). The approach involved testing the bioactivity of the negative-component blend (4c blend) for oviposition deterrence at three different doses (2, 0.2, and 0.02 mg CFFA equivalent/agar), compared with ethanol control. Further, neutral compound is added to the negative blend i.e., ‘negative+neutral’ component blend (5c blend) to identify key compounds for oviposition deterrence. The experiment was replicated five times per treatment.

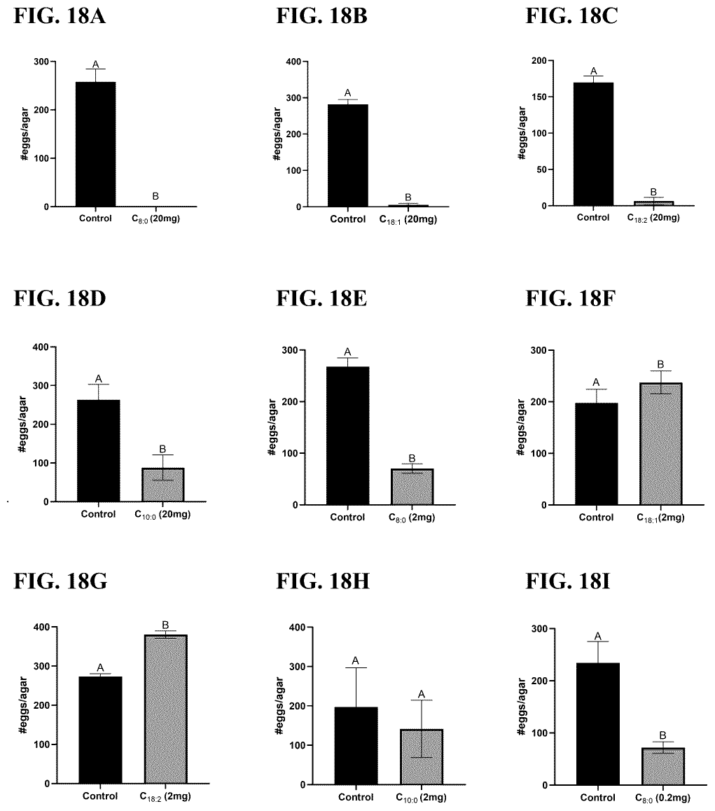

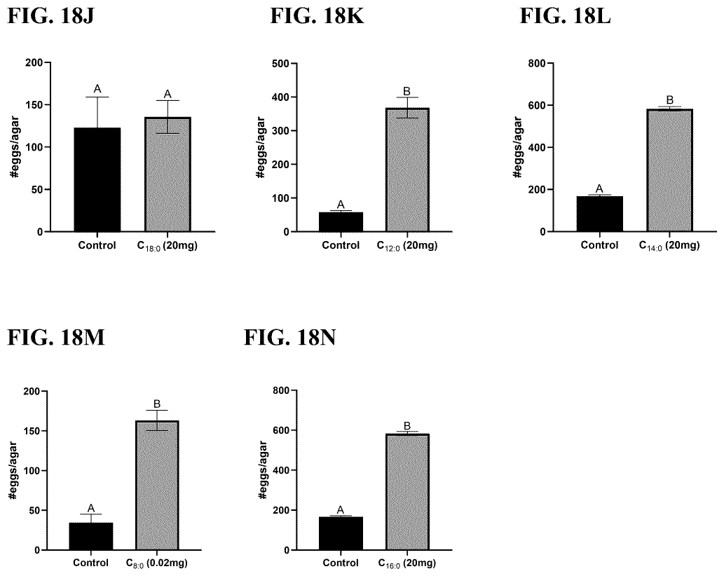

When eight individual components of CFFA were tested at 20 mg dose, four compounds (“negative” compounds: C_{8:0}, C10:0, C_{18:1}, C_{18:2}) significantly reduced Z. cucurbitae oviposition on pumpkin juice-infused agar compared to control agar, one compound (“neutral” compound: C_{18:0}) did not affect oviposition, and three compounds (“positive” compounds: C_{12:0}, C_{14:0}, C_{16:0}) increased the Z. cucurbitae oviposition. As seen in FIG. 18A to FIG. 18N, C_{8:0} reduced Z. cucurbitae oviposition by 100% (FIG. 18A, t=21.53%, P<0.0001), C_{18:1} reduced Z. cucurbitae oviposition by 98.1% (FIG. 18B, t=45.08, P<0.0001), C_{18:2} reduced Z. cucurbitae oviposition by 96.4% (FIG. 18C, t=34.87, P<0.0001), and C_{10:0} reduced Z. cucurbitae oviposition by 74% (FIG. 18D, t=7.56, P<0.0001), C_{18:0} did not affect oviposition (FIG. 18J, t=0.6862, P<0.0001), C_{12:0} increased the Z. cucurbitae oviposition by 86.4% (FIG. 18K, t=22.25, P<0.0001), C_{14:0} increased the Z. cucurbitae oviposition by 77.7% (FIG. 18L, t=78.80, P<0.0001), and C_{16:0} increased the Z. cucurbitae oviposition by 67.3% (FIG. 18N, t=79.16, P<0.0001). When negative compounds were individually tested at lower doses, C_{8:0} maintained oviposition deterrence at 2 mg dose (FIG. 18E), and down to 0.2 mg dose (FIG. 18I, t=12.03, P<0.0001), but not at 0.02 mg dose (FIG. 18M), while other compounds either lost oviposition deterrence or increased oviposition at 2 mg doses compared to their respective ethanol controls (see C_{18:1} in FIG. 18F, C_{18:2} in FIG. 18G, and C_{10:0} in FIG. 18H).

Table 4 below lists the amount of individual coconut free fatty acid (CFFA) components in 20 mg CFFA and 20 mg equivalent dose of synthetic blends treated on pumpkin juice agar (19.6 cm²) for Z. cucurbitae “negative compounds” blend (4c) and Z. cucurbitae “negative+neutral compounds” blend (5c).

TABLE 4
Coconut Free Fatty Acid Components Tested for Z. cucurbitae

| | | Amount in | 20 mg CFFA equivalent | |
|---|---|---|---|---|
| | | 20 mg | dose in synthetic blends | |
| | Behavioral | CFFA | tested (mg) | |
| CFFA components | activity | (mg) | 4c | 5c |
| Caprylic acid (C_{8:0}) | Negative | 1.38 | 1.38 | 1.38 |
| Capric acid (C_{10:0}) | Negative | 1.46 | 1.46 | 1.46 |
| Lauric acid (C_{12:0}) | Positive | 10.54 | | |
| Myristic acid (C_{14:0}) | Positive | 3.42 | | |
| Palmitic acid (C_{16:0}) | Positive | 1.68 | | |
| Stearic acid (C_{18:0}) | Neutral | 0.26 | | 0.26 |
| Oleic acid (C_{18:1}) | Negative | 1.2 | 1.2 | 1.2 |
| Linoleic acid (C_{18:2}) | Negative | 0.06 | 0.06 | 0.06 |
| Total | | 20 | 4.1 | 4.36 |

As seen in FIG. 19A, the mixture of four negative compounds (4c blend; Table 3) formulated at the equivalent concentrations as in 2 mg doses of CFFA significantly reduced Z. cucurbitae oviposition by 66.6% (t=2.67, P<0.0155). However, as seen in FIG. 19B, the oviposition reduction effect of the 4c blend was not observed at 0.2 mg CFFA equivalent dose (t=0.76, P<0.4584). As seen in FIG. 19C, adding the neutral compound (C_{18:0}) to the 4c blend (5c iii blend) resulted in 76.4% reduction in oviposition compared to control at 2 mg CFFA equivalent dose (t=9.02, P<0.0001). When the 4c and 5c-iii blends were compared at 2 mg CFFA equivalent dose, the 5c iii blend was 75.8% significantly more effective at reducing Z. cucurbitae oviposition then the 4c blend (t=7.15, P<0.0001; FIG. 19D). Adding any of the individual positive compounds to the 5c-iii blend resulted in a significant reduction in oviposition deterrence. The results for 5c-iii blend+C_{12:0} are shown in FIG. 19E (t=5.76, P<0.0004), the results for 5c-iii blend+C_{14:0} are shown in FIG. 19F (t=2.11, P<0.0670), and the results for 5ciii blend+C_{16:0}—are shown in FIG. 19G (t=4.68, P<0.0002).

When the 5c-iii blend was further tested in no-choice tests at 2 mg CFFA equivalent concentration. As seen on FIG. 20A, significant reduction in Z. cucurbitae oviposition was observed from the 5c-iii blend-treated agar compared to ethanol control agar (t=17.20, P<0.0001). The 5c-iii blend was effective at reducing Z. cucurbitae oviposition on one of its preferred host fruit, cucumber. As seen in FIG. 20B, the application of the 5ciii blend at 2 mg/agar CFFA equivalent dose, adjusted for the equivalent concentration in terms of unit surface area of fruit, resulted in 44% reduction in Z. cucurbitae oviposition compared to cucumbers treated with ethanol as a control (t=8.01, P<0.0001).

To understand the behavioral mode of CFFA compounds mediated oviposition reduction, the average number of visits and the cumulative duration of visits by a female fly on 5cii blend-treated agar vs untreated control agar were monitored over 24 hours using the EthoVision® video-tracking system (Noldus Inc., Leesburg, Virginia, USA). Five female Z. cucurbitae were released into a round arena (3 L beaker with transparent cover) provided with two pumpkin agar plates surface-treated either with 5c-iii blend or ethanol as described above. A network camera (GigE; Basler AG, Ahrenburg, Germany) was affixed 30 cm above the agar plates. An LED light box was placed under the arena to increase the contrast and fly tracking. The video was streamed to a computer and processed using EthoVision® to calculate the average number of target visits per fly and the cumulative duration (s) of visits per fly, and to generate a heat map. Each adult was considered a replicate and tested once only (N=25).

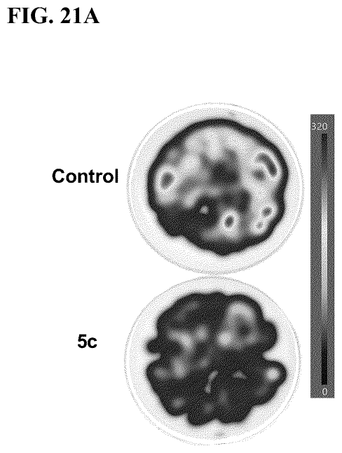

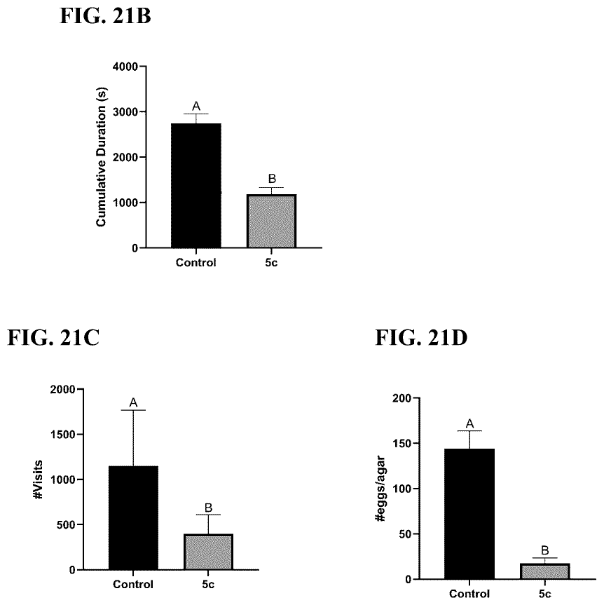

Behavior tracking studies were conducted to understand whether the 5c-iii blend-reduced Z. cucurbitae oviposition spatially and/or after contact. As seen in FIG. 21A, a heatmap that visualizes the movement of these flies in a two-choice setup indicated a significantly greater presence of Z. cucurbitae on the control agar than the 5c-iii blend-treated agar. FIG. 21C shows that female Z cucurbitae visited the 5c-iii blend-treated agar 74.3% less frequently (t=5.77, P<0.0001) and FIG. 21B shows that when they visited, they stayed on the 5c-iii blend-treated agar 69.8% shorter time (t=31.39, P<0.0001) when compared to the control agar. As seen in FIG. 21D, these behavioral changes resulted in 89.2% fewer eggs oviposited on the 5ci-ii blend-treated agar compared to the control agar (t=13.74, P<0.0001).

This Example shows that a blend of five CFFA components (5c-iii blend; caprylic acid, capric acid, stearic acid, oleic acid, and linoleic acid) has consistent oviposition deterrent effects on mated female Z. cucurbitae. The Example also shows that Z. cucurbitae females oviposit significantly fewer eggs on artificial oviposition substrate surface treated with the 5ciii blend in both choice and no-choice bioassays and on 5ciii blend-treated cucumber. Finally, at the concentration tested in this study, Z. cucurbitae made fewer visits to the 5c-iii blend-treated agar and once visited, stayed significantly shorter duration on the 5c-iii blend agar, suggesting that the behavioral mode of CFFA-mediated oviposition deterrence on Z. cucurbitae may be the combination of spatial repellence and contact deterrence at the concentration of the 5c-iii blend tested.

### Example 8

### Oviposition-Deterrence of Additional Fatty Acids

The oviposition deterrence of C_{4:0}˜C_{7:0}, C_{9:0}, C_{11:0}, C_{13:0}, C_{15:0}, C_{17:0}, and C_{19:0} to melon fly, and of C_{4:0}-C_{7:0} to OFF were determined.

Melon fly and oriental fruit fly (OFF) insects used in the present study were sourced from colonies at the U.S Pacific Basin Agricultural Research Center in Hilo, Hawaii and maintained on a standard larval diet containing wheat, sugar, and yeast (Tanaka et al.; Supra). Eclosed male and female cohorts were held for 12 to 18 days in screened cages (30 cm×30 cm×30 cm (W×L×H); BUGDORM-2120 Insect rearing tent and provisioned with sugar and protein hydrolysate as food at 24° C., 55-60% relative humidity, and 12L:12D photoperiod until used in the oviposition bioassays.

Oviposition bioassays were conducted using laboratory two-choice cage experiments with pumpkin juice-infused agar (for Melon fly) and guava juice-infused agar (for OFF) as oviposition substrate. The agar plates were prepared by pouring 10 mL of boiled agar mixture [1000 mL distilled water, 500 mL pumpkin or guava juice, 10 g agar, 0.6 g methylparaben, 6.7 mL 95% ethanol, and 3 mL acetic acid] into a small petri dish (60 mm×15 mm). The agar was then covered with a lid to avoid desiccation. The two-choice oviposition bioassay was conducted in screened cages using 20 mated melon fly or OFF females per cage (14-18 day-old; Jang et al.; Supra) over 24 hours. Each cage was provided with a ball of water-saturated cotton and sugar+protein hydrolysate mixture in separate 30 mL deli cups, and two agar plates-one treated with one of the test compounds (C_{4:0} (Butyric acid), C_{5:0} (Valeric acid), C_{6:0} (Caproic acid), C_{7:0} (Enanthic acid), C_{9:0} (Pelargonic acid), C_{11:0} (Undecylic acid), C_{13:0} (Tridecylic acid), C_{15:0} (Pentadecylic acid), C_{17:0} (Margaric acid), or C_{19:0} (Nonadecylic acid)) diluted in ethanol and the other treated with the ethanol which served as a control. The agar plates were surface-treated either with 200 μL of ethanol (control) or 200 μL of one of tested compounds diluted at 20 mg/200 μL of ethanol, placed into a fume hood for 10 minutes to evaporate solvents prior to be used in bioassays, and positioned upside-down (i.e. treated side down) on the center of the outside top of the screened cage 17 cm apart from each other (i.e. one each of control and treated), allowing female flies to oviposit on pumpkin (for melon fly) or guava juice (for OFF) agar from the bottom through the cage screen. After 24 hours, melon fly and OFF eggs in the agar were gently separated from the agar in water and the number of eggs were individually counted. The experiment was replicated five times per treatment.

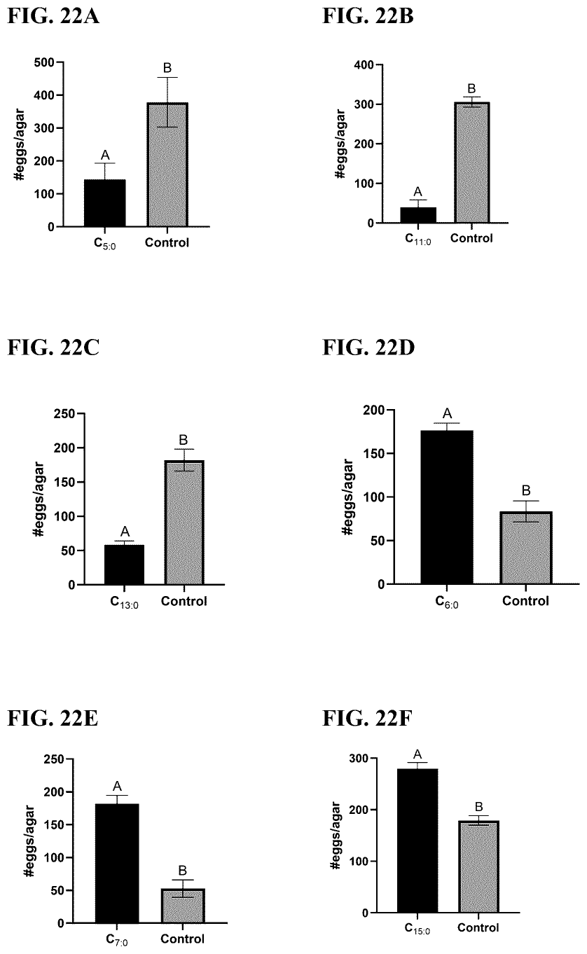

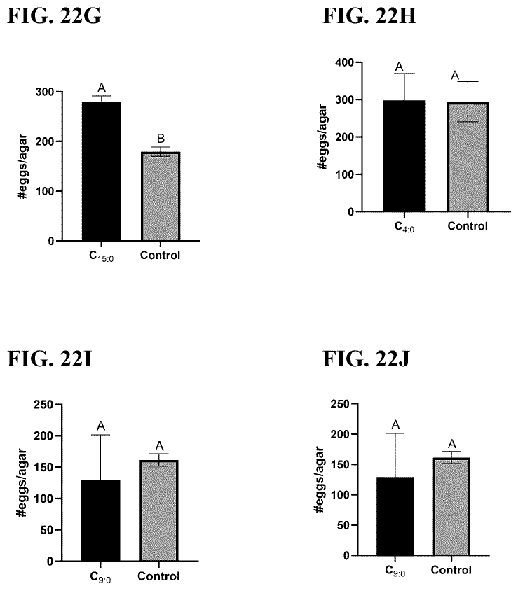

As seen in FIG. 22A to FIG. 22J, melon flies oviposited 72.5%-88.5%, and 75.7% significantly fewer eggs on pumpkin juice agar treated with 20 mg of C_{5:0} (t=5.8, P<0.001), C_{11:0} (t=25.7, P<0.001), and C_{13:0} (t=16.2, P<0.001), respectively, compared to control agar. In contrast, treating pumpkin agar with C_{6:0} (t=14.2, P<0.001), C_{7:0} (t=15.9, P<0.001), C_{15:0} (t=14.7, P<0.001), and C_{17:0} (t=7.3, P<0.001) resulted in increased melon fly oviposition compared to control, while C_{4:0} (t=0.09, P<0.9311), C_{9:0} (t=0.9, P<0.3525), and C_{19:0} (t=1.9, P<0.0929) did not affect melon fly oviposition.

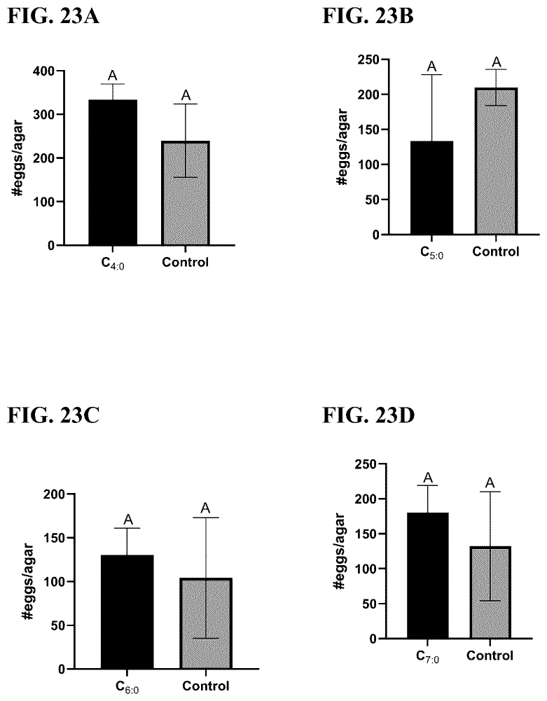

As seen in FIG. 23A to FIG. 23D, C_{4:0} (t=2.3, P<0.0511), C_{5:0} (t=1.7, P<0.1213), C_{6:0} (t=0.8, P<0.4568), and C_{7:0} (t=1.2, P<0.2492) did not affect OFF oviposition when treated on guava-juice infused agar as individual compounds at 20 mg dose.

The results in this Example show that C_{5:0}, C_{11:0}, and C_{13:0} deterred melon fly oviposition, and none of C_{4:0}, C_{5:0}, C_{6:0}, and C_{7:0} appeared to affect OFF oviposition.

### Example 9

### Spatial Repellency of Additional Fatty Acid Esters on B. dorsalis and Z. cucurbitae

The oviposition deterrence of fatty acid esters on B. dorsalis and Z. cucurbitae were studied.

The methods used to test the repellency of fatty acid methyl esters for OFF described above were used in this Example, with minor modifications. The only difference was that pumpkin juice was used as attractant in traps. Melon flies used in this study were from melon fly colony at the U.S Pacific Basin Agricultural Research Center in Hilo, Hawaii, which were maintained on a standard larval diet containing wheat, sugar, and yeast (Tanaka at al., Supra). Chemicals tested were C_{8:0}ME (Methyl octanoate), C_{10:0}ME (Methyl decanoate), C_{12:0}ME (Methyl laurate), C_{14:0}ME (Methyl tetradecanoate), C_{16:0}ME (Methyl palmitate), C_{18:0}ME (Methyl stearate), C_{18:1}ME (Methyl Oleate), and C_{18:2} (Methyl linoleate).

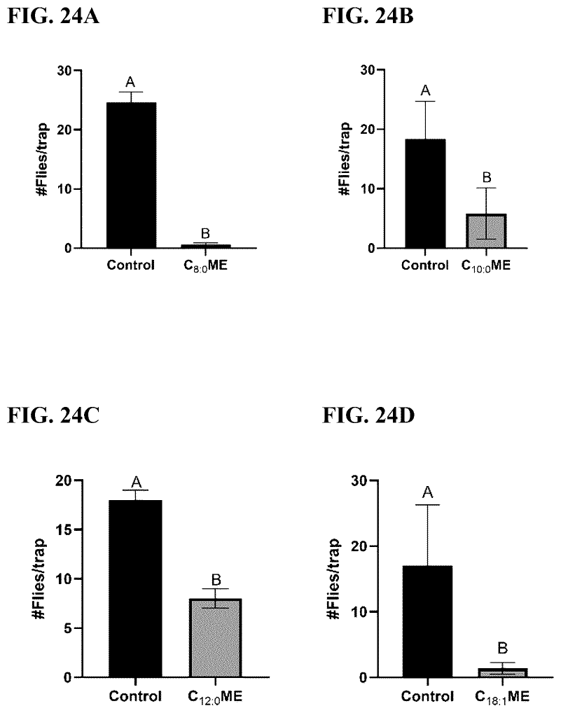

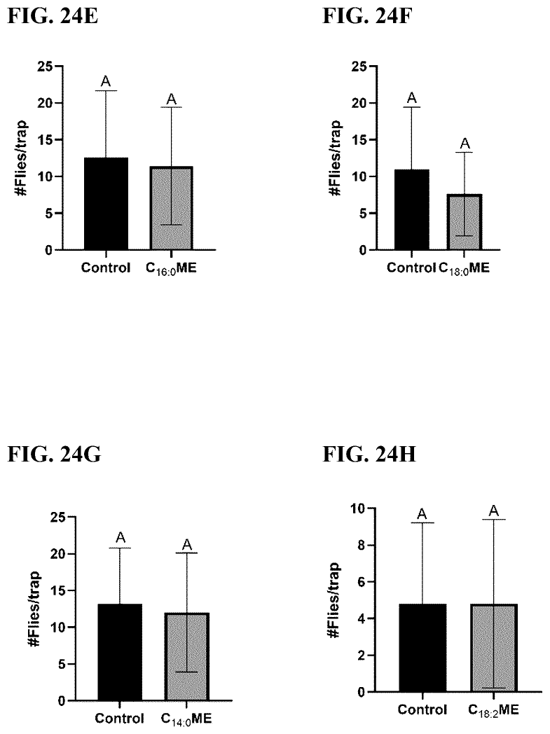

Among fatty acid methyl esters (FAME) tested, C_{8:0}ME (t=29.2, P<0.001; FIG. 24A), C_{10:0}ME (t=3.7, P<0.001; FIG. 24B), C_{12:0}ME (t=15.8, P<0.001; FIG. 24C), and C_{18:1}ME (t=3.7, P<0.001; FIG. 24D) showed significant repellency to Z. cucurbitae that resulted in 97.1%, 76.0%, 55.5%, and 91.8% fewer Z. cucurbitae captured in traps baited with the respective FAME, compared to unbaited control. However, C_{14:0}ME (t=0.2, P<0.8151; FIG. 19G), C_{16:0}ME (t=0.2, P<0.8303; FIG. 24E), C_{18:0}ME (t=0.7, P<0.4766; FIG. 24E), and C_{18:2}ME (t=0.1, P<0.9; FIG. 24H) did not affect melon fly behavior.

The results in this Example show that C_{8:0}ME, C_{10:0}ME, C_{12:0}ME, and C_{18:1}ME showed significant repellency to Z. cucurbitae.

We claim:

1. A fruit fly oviposition-deterrent composition comprising at least two coconut free fatty acids (CFA), caprylic acid (C8:0) and capric acid (C10:0), and optionally a carrier.

2. The composition of claim 1, further comprising at least one of oleic acid (C18:1) and linoleic acid (C18:2).

3. The composition of claim 1, wherein the CFA are caprylic acid (C8:0), capric acid (C:10:0), oleic acid (C18:1), and linoleic acid (C18:2).

4. The composition of claim 3, further comprising at least one of myristic acid (C14:0) or lauric acid (C12:0).

5. The composition of claim 4, wherein the CFA are caprylic acid (C8:0), capric acid (C:10:0), oleic acid (C18:1), linoleic acid (C18:2), and lauric acid (C12:0).

6. The composition of claim 4, wherein the CFA are caprylic acid (C8:0), capric acid (C:10:0), oleic acid (C18:1), linoleic acid (C18:2), and myristic acid (C14:0).

7. The composition of claim 4, wherein the CFA are caprylic acid (C8:0), capric acid (C:10:0), oleic acid (C18:1), linoleic acid (C18:2), myristic acid (C14:0), and lauric acid (C12:0).

8. The composition of claim 1, wherein the CFA are caprylic acid (C8:0), capric acid (C:10:0), stearic acid (C18:0), oleic acid (C18:1), and linoleic acid (C18:2).

9. The composition of claim 1, wherein the CFA are present in the composition from about 2 mg CFA-equivalent dose to about 20 mg CFA-equivalent dose.

10. The composition of claim 1, comprising an agronomically-, physiologically-, or pharmaceutically-acceptable carrier.

11. The composition of claim 10, wherein the carrier is a vegetable.

12. The composition of claim 1, wherein the composition is a concentrate, a solution, a spray, a powder, a granule, a gel, a wax, a net, or a film.

13. A method for deterring fruit fly oviposition on fruit, the method comprising treating the fruit or an area surrounding the fruit with the composition of claim 1.

14. A method for deterring fruit fly oviposition on fruit, the method comprising treating the fruit or an area surrounding the fruit with the composition of claim 2.

15. A method for deterring fruit fly oviposition on fruit, the method comprising treating the fruit or an area surrounding the fruit with the composition of claim 4.

16. The method of claim 13, wherein the CFA are present in the composition from about 2 mg CFA-equivalent dose to about 20 mg CFA-equivalent dose.

17. A kit for deterring fruit fly oviposition, the kit comprising the composition of claim 1.

18. A kit for deterring fruit fly oviposition, the kit comprising the composition of claim 2.

19. A kit for deterring fruit fly oviposition, the kit comprising the composition of claim 4.

20. The kit of claim 17, wherein the CFA are present in the composition from about 2 mg CFA-equivalent dose to about 20 mg CFA-equivalent dose.

21. A composition comprising at least one of heptanoic acid (C7:0), caprylic acid (C8:0), pelargonic acid (C9:0), methyl caprylate (C8:0 ME), methyl pelargonate (C9:0 ME), methyl caprate (C10:0 ME), methyl undecanoate (C11:0 ME), methyl laurate (C12:0 ME), methyl tridecanoate (C13:0 ME), and methyl pentadecanoate (C15:0 ME) to reduce female B. dorsalis attraction and oviposition in response to host fruit odors.
